(19) United States
(12) Patent Application Publication
(10) Pub. No.: US 2026/0056649 A1
(43) Pub. Date: Feb. 26, 2026

(54) TECHNIQUES FOR RESPONDING TO USERS

(71) Applicant: Apple Inc., Cupertino, CA (US)

(72) Inventors: Vincenzo O. GIULIANI, Thousand Oaks, CA (US); Christopher P. FOSS, San Francisco, CA (US); Erik R. KLIMCZAK, Mill Valley, CA (US); James F. FELKINS, San Jose, CA (US); Jessica J. PECK BROWN, Morgan Hill, CA (US); Lane FUJITA, Oakland, CA (US); Robert S. BOWLES SINCLAIR, Los Gatos, CA (US); Tyler C. LEPPEK, Santa Cruz, CA (US)

(21) Appl. No.: 19/322,320

(22) Filed: Sep. 8, 2025

Related U.S. Application Data
(60) Provisional application No. 63/692,617, filed on Sep. 9, 2024.
(60) Provisional application No. 63/877,753, filed on Sep. 8, 2025.

(51) Int. Cl. G06F 3/04842; G06F 3/16

(52) U.S. Cl. CPC G06F 3/04842; G06F 3/165

(57) ABSTRACT

The present disclosure generally relates to responding to users. Some techniques are for performing an operation that is specific to a user in accordance with some embodiments. Other techniques are for performing an ambiguous request related to displayed content in accordance with some embodiments.

### CROSS-REFERENCE TO RELATED APPLICATIONS

This application claims priority to U.S. Non-Provisional Patent Application Ser. No. 63/877,753, entitled “TECHNIQUES FOR RESPONDING TO USERS,” filed Sep. 8, 2025, and to U.S. Provisional Patent Application Ser. No. 63/692,617, entitled “TECHNIQUES FOR RESPONDING TO USERS,” filed Sep. 9, 2024, which are hereby incorporated by reference herein in their entireties for all purposes.

### FIELD

The present disclosure relates generally to computer user interfaces, and more specifically to techniques for responding to users.

### BACKGROUND

Electronic devices perform operations in response to user requests. Such requests can be personalized requests from an identified user or an ambiguous request from an unidentified user.

### SUMMARY

Some techniques for responding to requests using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for responding to users. Such processes and interfaces optionally complement or replace other processes for responding to users. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more output devices is described. In some embodiments, the method comprises: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a computer system configured to communicate with one or more input devices and one or more output devices is described. In some embodiments, the computer system comprises one or more processors and memory storing one or more programs configured to be executed by the one or more processors. In some embodiments, the one or more programs includes instructions for: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a computer system configured to communicate with one or more input devices and one or more output devices is described. In some embodiments, the computer system comprises means for performing each of the following steps: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an audio input corresponding to a subject; in response to detecting the audio input corresponding to the subject: in accordance with a determination that the audio input satisfies a first set of one or more criteria, wherein the first set of one or more criteria includes a criterion that is satisfied when the subject is able to be identified based on the audio input corresponding to the subject, outputting, via the one or more output devices, a first response; and in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, outputting, via the one or more output devices, a second response different from the first response; after outputting the second response and in accordance with a determination that the subject is still not able to be identified, capturing, via the one or more input devices, media of an environment; and in response to capturing the media of the environment: in accordance with a determination that the media of the environment satisfies a third set of one or more criteria, wherein the third set of one or more criteria includes a criterion that is satisfied when the subject is able to be identified based on the media of the environment, outputting, via the one or more output devices, the first response; and in accordance with a determination that the media of the environment satisfies a fourth set of one or more criteria different from the third set of one or more criteria, wherein the fourth set of criteria includes a criterion that is satisfied when the subject is not able to be identified based on the media of the environment, forgoing output of, via the one or more output devices, the first response.

In some embodiments, a method that is performed at a computer system that is in communication with one or more input devices and one or more display generation components is described. In some embodiments, the method comprises: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

In some embodiments, a transitory computer-readable storage medium storing one or more programs configured to be executed by one or more processors of a computer system that is in communication with one or more input devices and one or more display generation components is described. In some embodiments, the one or more programs includes instructions for: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

In some embodiments, a computer system configured to communicate with one or more input devices and one or more display generation components is described. In some embodiments, the computer system comprises means for performing each of the following steps: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; in response to detecting the input that includes the identification of the first visual characteristic: in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for responding to users, thereby increasing the effectiveness, efficiency, and user satisfaction with such devices. Such processes and interfaces may complement or replace other processes for responding to users.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6I illustrate exemplary user interfaces for responding to users in accordance with some embodiments.

FIG. 7 is a flow diagram illustrating a process for performing an operation that is specific to a user in accordance with some embodiments.

FIG. 8 is a flow diagram illustrating a process for performing an operation based on an ambiguous request related to displayed content in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for responding to users. For example, requests for operations can be executed based on the identification of the requesting user. As another example, ambiguous requests from a requesting user can be executed based on descriptive terms included in the request. Such techniques can reduce the cognitive burden on a user who requests an operation, thereby enhancing productivity. Further, such techniques can reduce processor and battery power otherwise wasted on redundant user inputs.

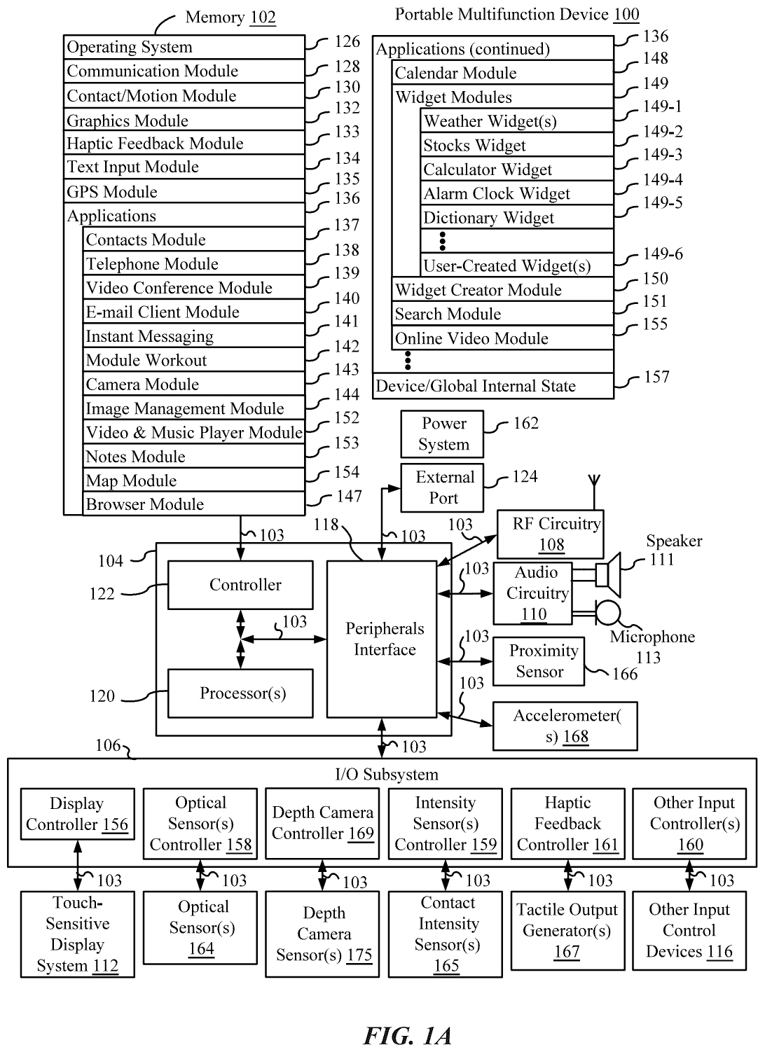

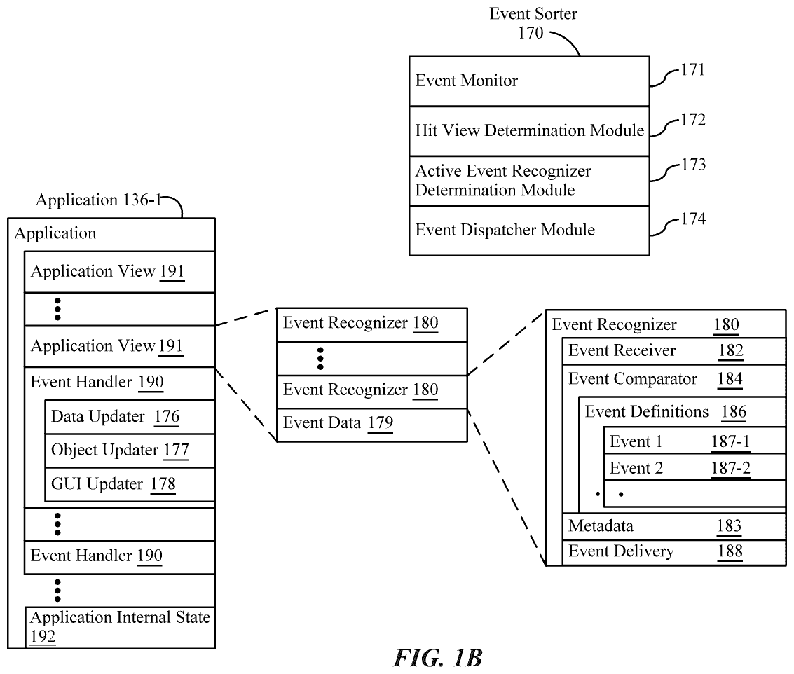

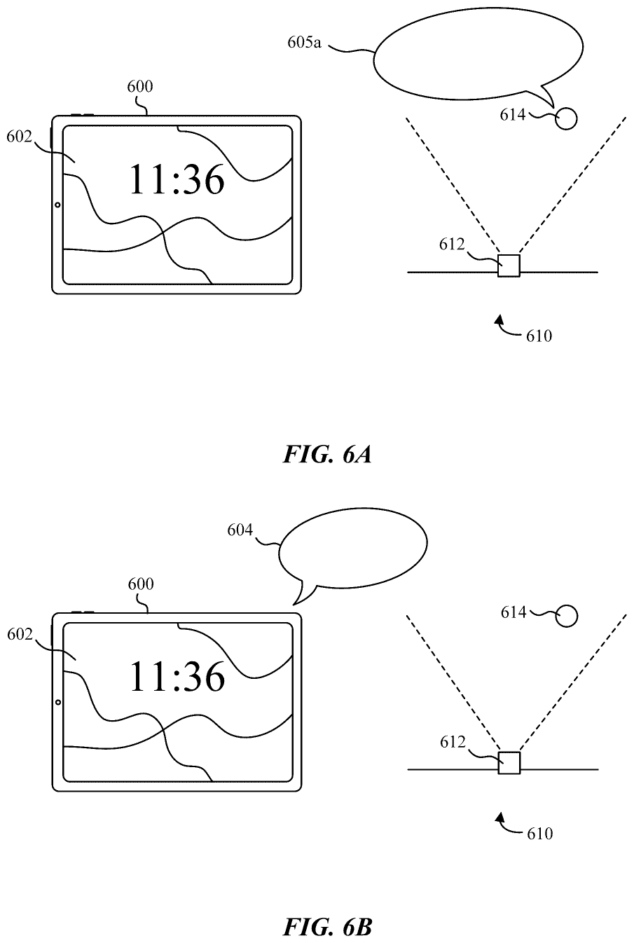

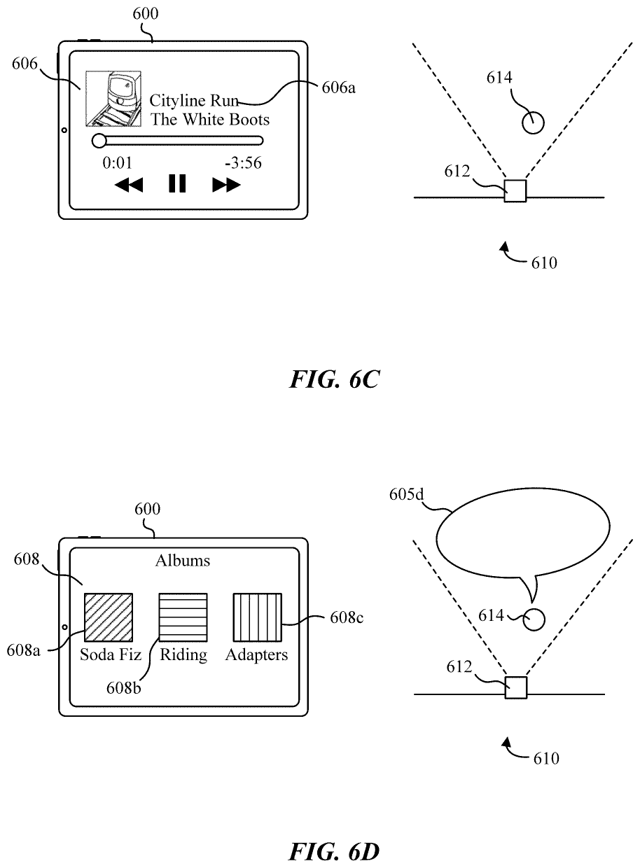

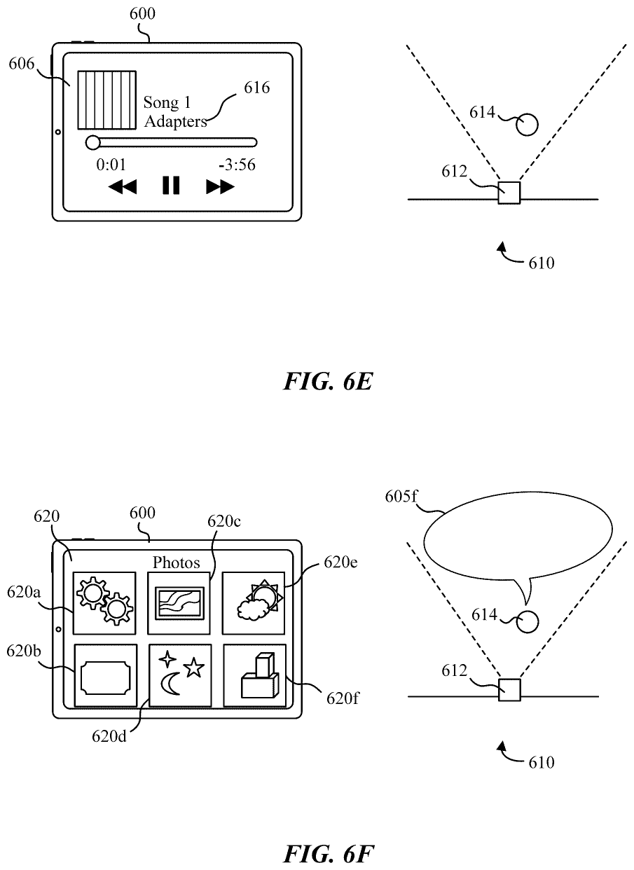

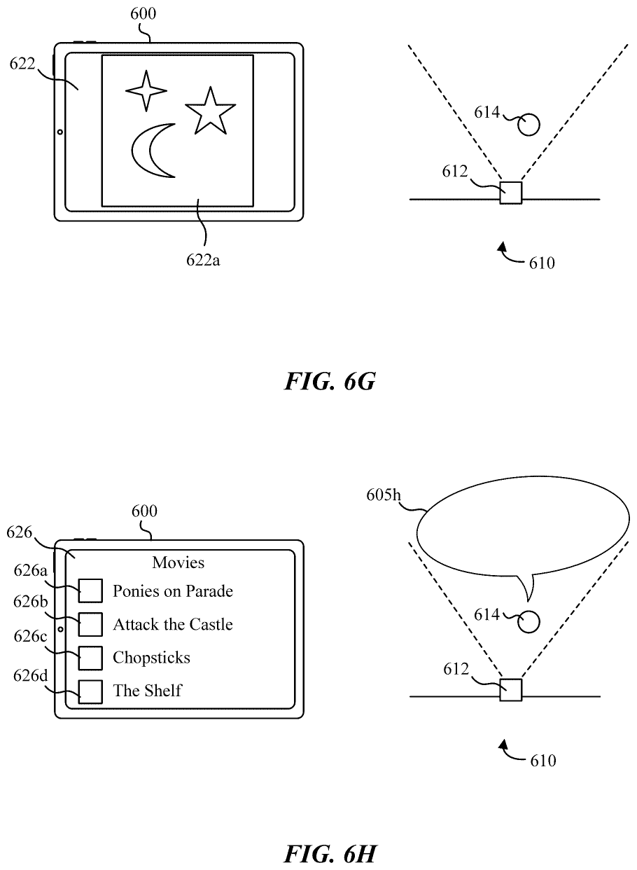

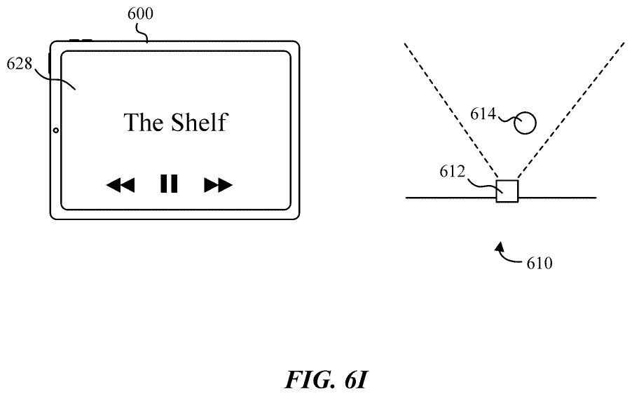

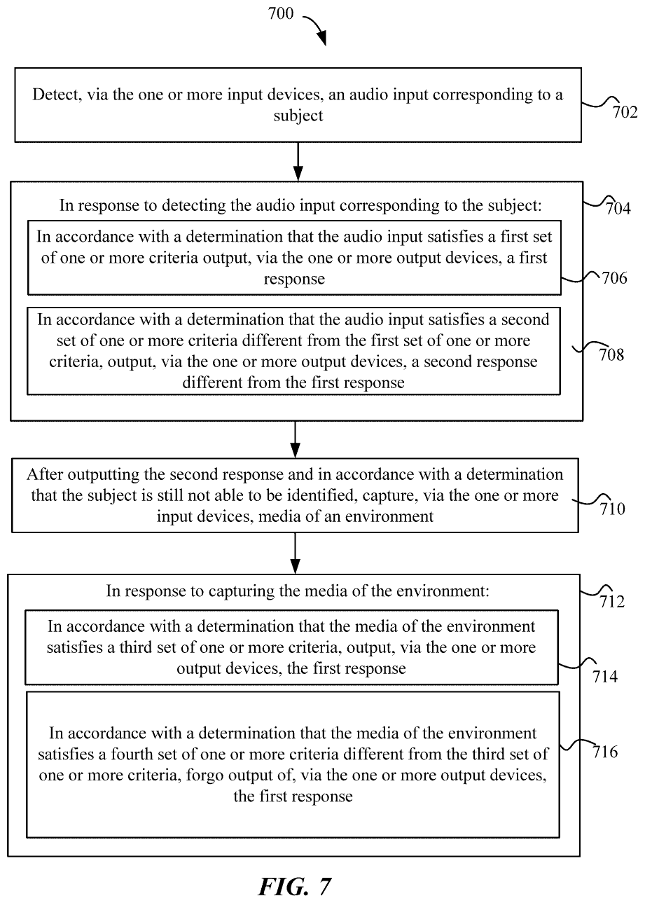

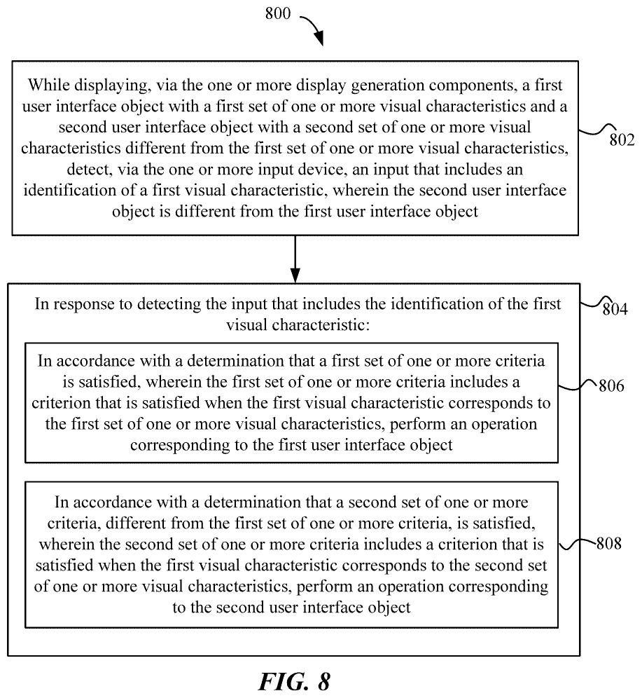

Below, FIGS. 1A-1B, 2, 3A-3G, 4A-4B, and 5A-5B provide a description of exemplary devices for performing the techniques for responding to users. FIGS. 6A-6I illustrate exemplary user interfaces for responding to users in accordance with some embodiments. FIG. 7 is a flow diagram illustrating a process for performing an operation that is specific to a user in accordance with some embodiments. The user interfaces in FIGS. 6A-6I are used to illustrate the processes described below, including the processes in FIG. 7. FIG. 8 is a flow diagram illustrating a process for performing an operation based on an ambiguous request related to displayed content in accordance with some embodiments. The user interfaces in FIGS. 6A-6I are used to illustrate the processes described below, including the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an email application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (110) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoTP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

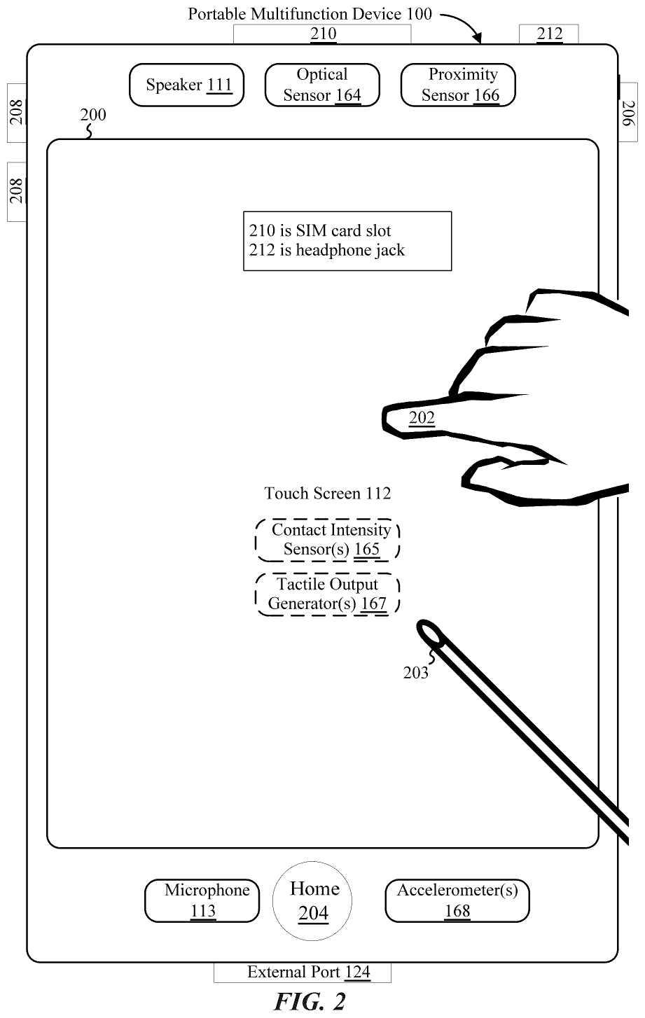

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

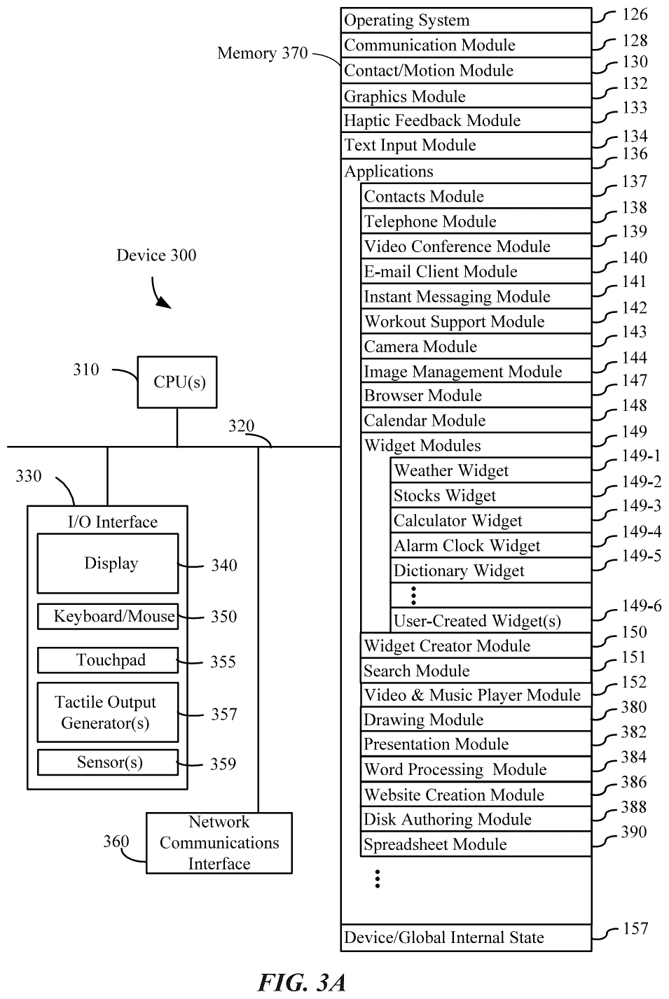

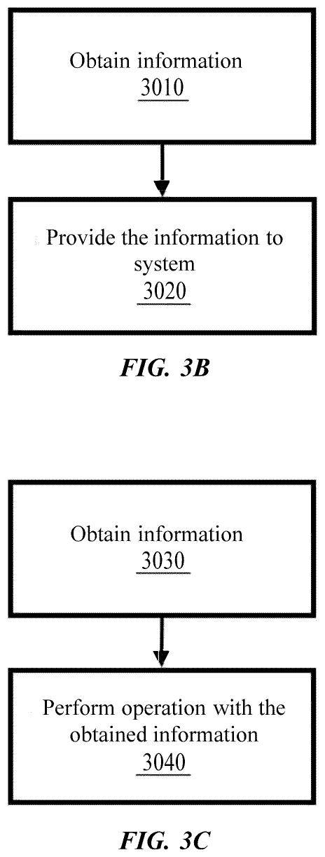

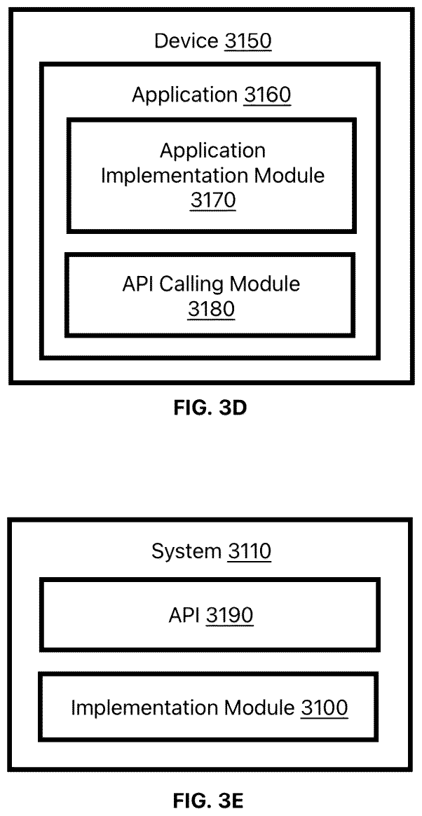

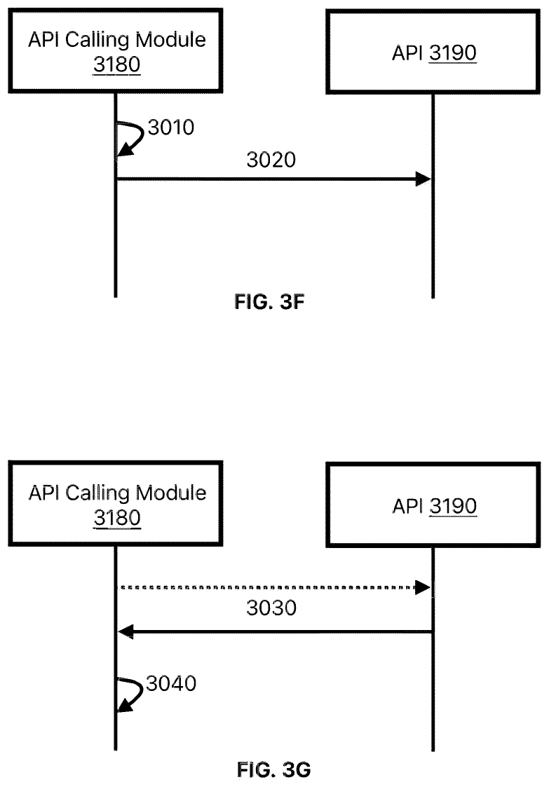

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, email 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to subevents of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or subevent, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the process of FIG. 3B, the process of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the process of FIG. 3B and/or the process of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the process of FIG. 3B and/or the process of FIG. 3C by calling an application programming interface (API) (e.g., API 3190) provided by system 3110. In some embodiments, application 3160 performs at least a portion of the process of FIG. 3B and/or the process of FIG. 3C without calling API 3190.

In some embodiments, one or more steps of the process of FIG. 3B and/or the process of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, PIU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 800 (FIGS. 7 and 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

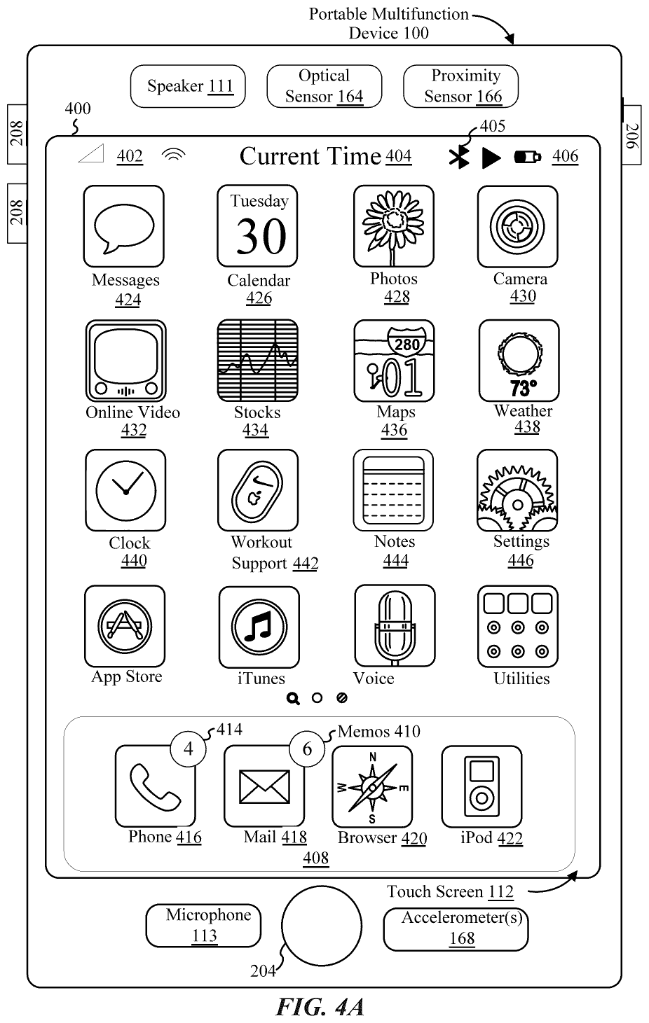

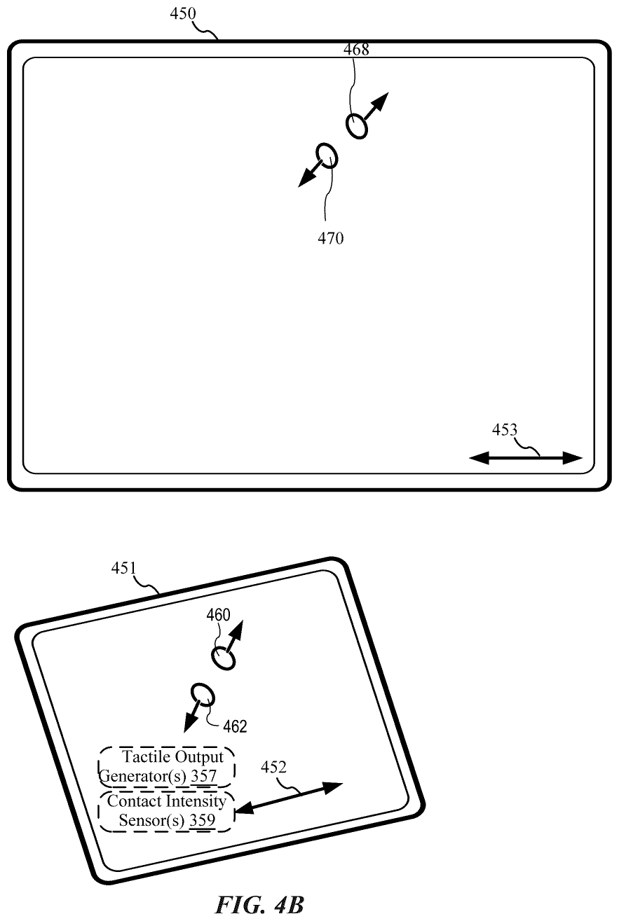

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

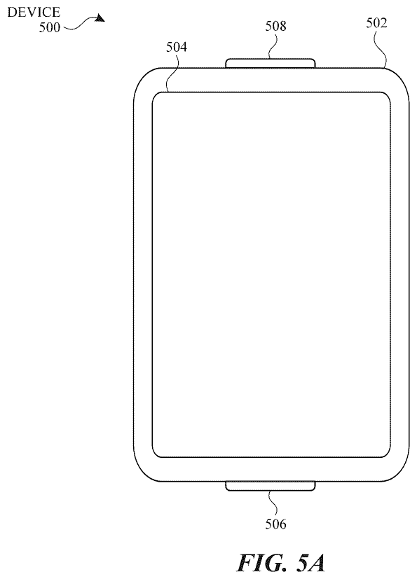

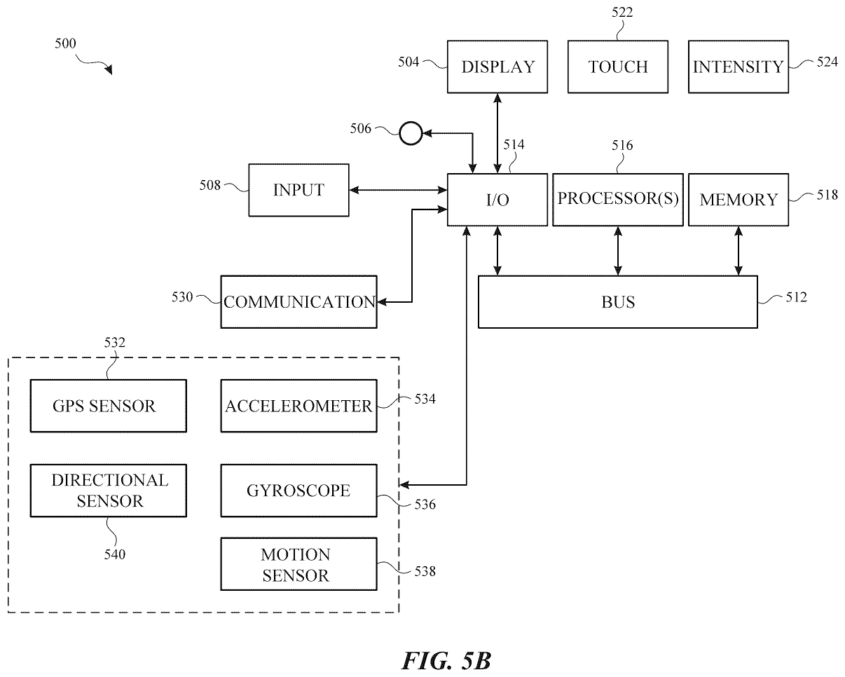

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6I illustrate exemplary user interfaces for receiving requests and performing operations in accordance with some embodiments. The user interfaces in these figures are used to illustrate the processes described below, including the processes in FIGS. 7-8.

FIGS. 6A-6I illustrate exemplary user interfaces for responding to users in accordance with some embodiments. The user interfaces in these figures are used to illustrate the processes described below, including the processes in FIGS. 7-8.

The left side of FIGS. 6A-6I illustrate computer system 600 as a tablet. It should be recognized that computer system 600 can be other types of computer systems such as a smart watch, a smartphone, a laptop, a communal device, an accessory, a personal gaming system, a desktop computer, a fitness tracking device, and/or a head mounted display (HMD) device. In some embodiments, computer system 600 includes one or more features and/or components as described above with respect to computer system 100 and/or device 200.

The right side of FIGS. 6A-6I include diagram 610, which is a representation of an environment that contains computer system 600 and a user. In diagram 610, computer system representation 612 represents computer system 600 and user representation 614 represents the user. The position of user representation 614 within diagram 610 relative to computer system representation 612 is representative of the position of the user relative to computer system 600. Diagram 610 also contains two dashed lines representing the edge of the field of detection of computer system 600 which is the field of view and/or detection of one or more cameras of computer system 600. When user representation 614 is illustrated between the two dashed lines, the user is within the field of detection of computer system 600. In some embodiments, computer system 600 maintains the user (e.g., as represented by user representation 614) within the field of detection of computer system 600. In such embodiments, computer system 600 can use machine learning to help keep the user centered in an image or a video captured by computer system 600. For example, computer system 600 can locate the user using machine learning and then edit the image or the video so as the user is in a particular location (e.g., in the center, on an edge, or in a peripheral location) within the image or the video as the user moves around. It should be recognized that, while some embodiments described herein refer to inputs being voice inputs that are detected via one or more microphones, other types of inputs can be used with techniques described herein, such as touch inputs detected via one or more touch-sensitive surfaces, gaze inputs that are detected via one or more cameras, and/or air gestures detected via one or more cameras.

As illustrated in FIG. 6A, computer system 600 displays lock screen user interface 602. At FIG. 6A, the user is at the far end of and within the field of detection of computer system 600 as indicated by user representation 614 being illustrated in between the ends of the two dashed lines farthest from computer system representation 612 within diagram 610. At FIG. 6A, computer system 600 detects verbal input 605a from the user that corresponds to a request for computer system 600 to play the user's favorite song. At FIG. 6A, computer system 600 cannot identify the user from verbal input 605a. It should be recognized that, although computer system 600, as illustrated, detects verbal input 605a while computer system 600 is in a locked state at FIG. 6A, computer system 600 can detect verbal input 605a while computer system 600 is in a lower power mode, a standby mode, an unlocked state, and/or a high power mode.

At FIG. 6B, in response to detecting verbal input 605a and not being able to identify the user, computer system 600 outputs content 604 in the form of audio indicating that the user should come closer to computer system 600. In some embodiments, content 604 corresponds to instructions for the user to repeat verbal input 605a. For example, content 604 can include the phrase, “I can't tell who is talking. Can you come closer?” In some embodiments, content 604 corresponds to instructions for the user to speak at a higher volume. For example, content 604 can include the phrase, “I did not get that. Can you say it louder?” In some embodiments, content 604 corresponds to instructions for the user to decrease to volume of media within the environment. For example, content 604 can include the phrase, “I did not understand. Can you turn down the television?” In some embodiments, content 604 corresponds to instructions for the user to decrease other noise within the environment. For example, content 604 can include the phrase, “I did not understand. Can you close the window?” or “Can you stop the dog from barking?”

In some embodiments, computer system 600 outputs content 604 as audio in the direction of the user via one or more speakers connected to and/or in communication with computer system 600. For example, in response to computer system 600 detecting the user to the right of computer system 600, computer system 600 outputs content 604 as audio to the right. For another example, in response to detecting that the user is near a smart speaker that is in communication with computer system 600, computer system 600 outputs content 604 as audio via the smart speaker near the user.

In some embodiments, in response to detecting verbal input 605a and not being able to identify the user, computer system 600 displays visual content in addition to and/or instead of outputting content 604. For example, the visual content can include text indicating to the user that the user should come closer to computer system 600 while outputting audio indicating the user should come closer to computer system 600. For another example, the visual content can include an animation of a person walking closer to computer system 600. In some embodiments, as part of outputting content 604, computer system 600 alters the content displayed by computer system 600. For example, as part of outputting content 604, computer system 600 enhances the colors (e.g., make the colors brighter and/or more saturated) within lock screen user interface 602 as a visual indication that the computer system 600 is outputting audio content (e.g., content 604) that requires a reaction (e.g., response) from the user.

In some embodiments, in response to detecting verbal input 605a and not being able to identify the user, computer system 600 outputs an indication (e.g., an audible and/or visual indication) that the user cannot be identified. For example, in response to detecting verbal input 605a and not being able to identify the user, computer system 600 displays a user icon with a question mark overlayed on top of the user icon. For another example, in response to detecting verbal input 605a and not being able to identify the user, computer system 600 outputs an audio tone.

At FIG. 6B, after computer system 600 outputs content 604, the user moves to a position closer to computer system 600 so computer system 600 can attempt to identify the user again. At FIG. 6B, after a predetermined period of time after outputting content 604, computer system 600 captures media (e.g., video, image, and/or audio) of the environment including the user. In some embodiments, the media captured by computer system 600 is not saved by computer system 600 and/or another computer system in communication with computer system 600. Instead, the media is deleted after being used to attempt to identify the user. In other embodiments, the media is saved by computer system 600 and can be used at a future time to identify the user. In other embodiments, the media is used to update a profile for identifying the user without requiring storage of the media and, after, deleted.

In some embodiment, computer system 600 outputs an indication (e.g., visual and/or auditory) that one or more input devices (e.g., microphones and/or cameras) of computer system 600 are active prior to computer system 600 capturing the media of the environment. For example, to indicate that the one or more input devices of computer system 600 are active, computer system 600 illuminates a red LED included in the frame of computer system 600 and/or outputs audio of a bell tone. For another example, to indicate that the one or more input devices of computer system 600 are active, computer system 600 illuminates an external light connected to computer system 600.

In some embodiments, in response to detecting verbal input 605a and not being able to identify the user while detecting that the user is not within the line of sight of computer system 600, computer system 600 does not capture information (e.g., audio or media) of the environment. For example, if computer system 600 detects verbal input 605a as coming from behind computer system 600 and not within the line of sight, computer system 600 does not capture information from the environment. In some embodiments, in response to detecting verbal input 605a and not being able to identify the user while detecting that the user is not within the light of sight of computer system 600, computer system 600 captures media via one or more microphones and does not capture audio, visuals, or media via one or more cameras. For example, computer system 600 outputs audio corresponding to asking the user to repeat what they said and captures the audio of the user repeating the request via one or more microphones. In some embodiments, in response to detecting verbal input 605a and not being able to identify the user while detecting that the user is within the field of detection, computer system 600 captures audio, visuals, or media via one or more cameras and does not capture content via one or more microphones.

In some embodiments, computer system 600 detects the location of the user by detecting the location of another computer system that is in the possession of the user and is in communication with computer system 600. For example, computer system 600 detects the location of the user by detecting the location of a smart watch worn by the user.

In some embodiments, computer system 600 identifies the user by sound and/or voice recognition and does not require the user to be within the line of sight of computer system 600. For example, computer system 600 identifies the user by the sound of verbal input 605a, resulting in computer system 600 reacting as described with respect to FIG. 6C instead of as described with respect to FIG. 6B. In some embodiments, computer system 600 identifies the user by the other computer system that is in possession of the user and is in communication with computer system 600. For example, computer system 600 identifies the user based on a smart phone that computer system 600 detects that is in the possession of the user. In some embodiments, computer system 600 identifies the user using a known profile of the user. For example, computer system 600 identifies the user by the sound of verbal input 605a matching a voice profile (e.g., voiceprint and or voice biometrics) included in the known profile of the user (e.g., the user corresponding to user representation 614). For another example, in response to capturing an image and/or a video of the environment, computer system 600 identifies the user using facial recognition that matches facial biometrics included in the known profile of the user.

In some embodiments, computer system 600 is outputting audio (e.g., music, radio, podcast, show, movie, and/or audio book) via one or more speakers of and/or in communication with computer system 600 when computer system 600 detects verbal input 605a. In such embodiments, in response to detecting verbal input 605a, computer system 600 suspends outputting or reduces a volume of the audio before outputting content 604. For example, if computer system 600 is outputting audio of a live radio broadcast, computer system 600 ceases outputting the audio of the radio broadcast in response to detecting verbal input 605a before outputting content 604. For another example, if computer system 600 is outputting video and audio of a movie, computer system 600 pauses outputting the video and/or the audio of the movie in response to detecting verbal input 605a before outputting content 604.

At FIG. 6C, the user is closer to computer system 600, as indicated by user representation 614 being closer to computer system representation 612 within diagram 610 than user representation 614 is to computer system representation 612 within diagram 610 in FIG. 6B. At FIG. 6C, computer system 600 identifies the user via the media captured after the user moves closer to computer system 600. At FIG. 6C, in response to detecting verbal input 605a and identifying the user, computer system 600 outputs content corresponding to verbal input 605a (e.g., plays the user's favorite song). It should be recognized that computer system 600 does not require another verbal input requesting to play the user's favorite song and instead outputs the content in response to initial request (e.g., verbal input 605a). As illustrated in FIG. 6C, in response to detecting verbal input 605a and identifying the user, computer system 600 displays media user interface 606 including media content 606a and ceases display of lock screen user interface 602. In some embodiments, in response to detecting verbal input 605a and identifying the user, computer system 600 plays the user's favorite song while continuing to display lock screen user interface. In some embodiments, computer system 600 selects a song by analyzing data corresponding to songs computer system 600 has access to such as how often the user plays the songs, how the user has rated the songs, and/or the volume at which the user plays the songs.

In some embodiments, in response to identifying the user, computer system 600 activates (e.g., applies one or more features of, initiates, logs into, and/or switches to) a profile (and/or account) corresponding to (e.g., related to and/or associated with) the user. In some embodiments, computer system 600 deactivates any other user profiles in conjunction with activating the user profile of the user. In some embodiments, deactivating the profile can include deleting content obtained by computer system 600 (e.g., from a personal device corresponding to another user profile and/or another user different from the user), changing content on a user interface, and/or switching profiles).

In some embodiments, in response to identifying the user, computer system 600 outputs an indication that the user is identified and/or the profile is activated. For example, in response to identifying the user, computer system 600 displays a user icon that is associated with the user and/or the profile at the top of the user interface (e.g., lock screen user interface and/or media user interface 606) that is displayed by computer system 600. In some embodiments, the indication that the user is identified includes the user's username that is registered with computer system 600. For example, in response to identifying the user, computer system 600 displays the user's username with the user icon that is associated with the user at the top of the user interface displayed by computer system 600. In some embodiments, in response to identifying the user and detecting verbal input 605a, computer system 600 displays the indication that the user is identified concurrently with displaying media user interface 606 and ceasing display of lock screen user interface 602.

In some embodiments, computer system 600 does not identify the user via the media captured after the user moves closer to computer system 600. For example, computer system 600 is not able to identify the user via the media captured after the user moves closer to computer system 600. In such embodiments, after the user moves closer to computer system 600 and/or in response to a determination that the user is not able to be identified, computer system 600 initiates a security protocol to verify, authenticate, and/or confirm the user. In some embodiments, the security protocol is completed on another computer system (e.g., personal device and/or external device) that is external to computer system 600. In such embodiments, the other computer system can be a personal device of the user. In some embodiments, the security protocol is initiated on multiple nearby devices (e.g., within a predetermined distance of computer system 600 and/or devices connected to the same wireless connections). In some embodiments, computer system 600 recognizes a voice of the user and initiates a security protocol for confirmation on a personal device of the user. In such embodiments, initiating the security protocol can include requesting a passcode from the user. In other embodiments, the security protocol can include requesting biometric information from the user. In other embodiments, initiating the security protocol can include displaying a code that must then be entered on a personal device of the user.

As illustrated in FIG. 6D, at a time after computer system 600 outputs the content corresponding to verbal input 605a, computer system 600 displays album selection user interface 608 which includes soda album control, 608a, riding album control 608b, and adapters album control 608c. Each album control (e.g., soda album control 608a, riding album control 608b, and adapters album control 608c) is a selectable control and includes an image of a different colored album cover such as soda album control 608a includes an image of a red album cover, riding album control 608b includes an image of a green album cover, and adapters album control 608c includes an image of a blue album cover. In some embodiments, computer system 600 displays more or less than three album controls within album selection user interface 608. At FIG. 6D, computer system 600 detects verbal input 605d from the user corresponding to a request to play the album that is the color blue.

At FIG. 6E, in response to detecting verbal input 605d, computer system 600 outputs content corresponding to verbal input 605d (e.g., play the blue album) and ceases display of album selection user interface 608. As illustrated in FIG. 6E, outputting the content includes displaying media user interface 606 with media content 616. Media content 616 corresponds to adapters album control 608c which, as described with respect to FIG. 6D, includes an image of a blue album cover. In some embodiments, outputting the content includes outputting audio (e.g., plays music on an album corresponding to adapters album control 608c) corresponding to verbal input 605d. In some embodiments, computer system 600 selects an album by analyzing data corresponding to the albums within album selection user interface 608 such as metadata analysis and/or image analysis of the album covers.

In some embodiments, in response to completing playback of the music on the album corresponding to adapters album control 608c, computer system 600 ceases display of media user interface 606 and redisplays album selection user interface 608 as illustrated with respect to FIG. 6D. In some embodiments, verbal input 605d corresponds to another album control displayed by computer system 600, resulting in computer system 600 displaying media user interface 606 with media content that corresponds to the other album control. For example, in response to computer system 600 detecting verbal input 605d and determining that verbal input 605d includes a reference to a green album cover, computer system 600 displays media user interface 606 with media content that corresponds to riding album control 608b.

As illustrated in FIG. 6F, at a time after outputting content corresponding to verbal input 605d, computer system 600 displays photo selection user interface 620 which includes controls with reduced size and/or compressed images (e.g., thumbnails) of digital photographs. The controls displayed by computer system 600 within photo selection user interface 620 include gears photo control 620a, sign photo control 620b, painting photo control 620c, moon photo control 620d, sun photo control 620e, and blocks photo control 620f. Each of the photo controls are selectable controls and contain an image of one or more objects: gears photo control 620a includes an image of gears, sign photo control 620b includes an image of a sign, painting photo control 620c includes an image of a painting, moon photo control 620d includes an image of the moon and stars, sun photo control 620e includes an image of the sun and clouds, and blocks photo control 620f includes an image of stacked blocks. In some embodiments, computer system 600 displays more or less than six photo controls within photo selection user interface 620. At FIG. 6F, computer system 600 detects verbal input 605f corresponding to a request to display a photo that contains stars.

As illustrated in FIG. 6G, in response to detecting verbal input 605f, computer system 600 outputs content corresponding to verbal input 605f, which includes computer system 600 displaying photo user interface 622 with moon photo image 622a and ceasing display of photo selection user interface 620. Moon photo image 622a corresponds to moon photo control 620d and is a larger and/or less compressed version of the image in moon photo control 620d. In some embodiments, verbal input 605f corresponds to another photo control displayed by computer system 600, resulting in computer system 600 displaying photo user interface 622 with an image corresponding to the other photo control. For example, in response to detecting verbal input 605f as corresponding to sign photo control 620b, computer system 600 displays photo user interface 622 with a larger and/or less compressed version of the image in sign photo control 620b.

As illustrated in FIG. 6H, at a time after displaying photo user interface, computer system 600 displays movie list user interface 626 which includes controls for selecting movies such as Ponies on Parade movie control 626a, Attack the Castle movie control 626b, Chopsticks movie control 626c, and The Shelf movie control 626d. In some embodiment, computer system 600 displays more or less than four movie selecting controls within movie list user interface 626. At FIG. 6H, computer system 600 detects verbal input 605h corresponding to a request to play a movie with a dragon.

As illustrated in FIG. 6I, in response to detecting verbal input 605h, computer system 600 outputs content corresponding to verbal input 605h which includes displaying video media user interface 628 with the movie that corresponds to The Shelf movie control 626d. At FIG. 6I, as part of outputting content corresponding to verbal input 605h, computer system 600 ceases display of movie list user interface 626. In some embodiments, computer system 600 outputs audio as part of outputting content corresponding to verbal input 605h. As discussed above, the title of the movie does not give an indication that the movie contains a dragon and computer system 600 selects a movie by analyzing data corresponding to the movies within movie list user interface 626 such as metadata analysis, natural language process of a summary of the movie, and/or machine learning models of reviews associated with the movie. In some embodiments, computer system 600 is familiar with the content of movies that computer system 600 has access to and uses that familiarity to select which movie corresponds with verbal input 605h. In some embodiments, computer system 600 scans the movies for content corresponding to verbal input 605h. In some embodiments, verbal input 605h corresponds to another movie selection control displayed by computer system 600, resulting in computer system 600 displaying video media user interface 628 with a movie that corresponds to the other movie selection control. For example, in response to detecting verbal input 605h as corresponding to a movie with noodles, computer system 600 displays video media user interface 628 with a movie that corresponds to Chopsticks movie control 626c.

In some embodiments, more than one user interface object (e.g., music album, photo, and/or video selection controls) displayed by computer system 600 has characteristics that correspond to a verbal input (e.g., verbal input 605a, verbal input 605d, verbal input 605f, and/or verbal input 605h) detected by computer system 600. For example, computer system 600 displays multiple album cover controls (e.g., soda album control 608a, riding album control 608b, and/or adapters album control 608c) within album selection user interface 608 that have blue as a component of the album art as requested in verbal input 605d. In such embodiments, in response to detecting a verbal input, computer system 600 selects a user interface object that has a greater amount and/or degree of the characteristic that corresponds to the verbal input. For example, computer system 600 selects the album cover control with the most amount blue within the album art. For another example, computer system 600 selects the album cover control with the most saturated blue. In some embodiments, no user interface object (e.g., music album covers, photos, and/or videos) displayed by computer system 600 has characteristics that correspond to the verbal input detected by computer system 600. For example, there are no photos that contain the image of starts as requested in verbal input 605f. In such embodiments, computer system 600 does not perform an operation and/or output content corresponding to the detected verbal input allowing for computer system 600 to output an error message. For example, in response to detecting a verbal input that does not correspond to a user interface object, computer system 600 displays an error message and outputs a tone to alert the user that content corresponding to the verbal input was not found.

In some embodiments, the number of user interface objects is more than computer system 600 can display at one time, and the user interface object corresponding to the verbal input detected by computer system 600 is in a list that is partially displayed but the user interface object corresponding to the verbal input is not currently displayed by computer system 600. In some such embodiments, in response to detecting the verbal input, computer system 600 performs an operation and/or outputs content that corresponds to the user interface object that corresponds to the verbal input. In other such embodiments, computer system 600 does not perform an operation and/or output content that corresponds to the user interface object that corresponds to the verbal input because the user interface object is not displayed. As discussed above, this allows for computer system 600 to output an error message. For example, in response to detecting a verbal input that correspond to a user interface object that is not displayed by computer system 600, computer system 600 outputs an audio message to inform that none of the displayed user interface objects correspond to the verbal input.

In some embodiments, in response to detecting an input while computer system 600 is performing an operation, computer system 600 ceases performance of the operation. For example, in response to computer system 600 detecting verbal input 605d while outputting the audio of the album that corresponds to soda album control 608a, computer system 600 stops outputting the audio. In some such embodiments, computer system 600 resumes outputting the operation at a time after detecting an input. For example, if voice input 605b does not correspond to a user interface object displayed by computer system 600, computer system 600 resumes outputting audio of the album that corresponds to soda album control 608a. In some embodiments, computer system 600 ceases performance of an operation that corresponds to a user interface object when performing an operation that corresponds to another user interface object. For example, in response to detecting verbal input 605d while outputting the audio of the album that corresponds to soda album control 608a, computer system 600 ceases output of the audio of the album that corresponds to soda album control 608a and outputs the audio for the album that corresponds to adapters album control 608c.

FIG. 7 is a flow diagram illustrating a process (e.g., process 700) for performing an operation that is specific to a user in accordance with some embodiments. Some operations in process 700 are, optionally, combined, the orders of some operations are, optionally, changed, and some operations are, optionally, omitted.

As described below, process 700 provides an intuitive way for performing an operation that is specific to a user. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication with one or more input devices (e.g., a camera, a depth sensor, a microphone, a hardware input mechanism, a rotatable input mechanism, a heart monitor, a temperature sensor, and/or a touch-sensitive surface) and one or more output devices (e.g., a display generation component, an audio generation component, and/or a haptic device). In some embodiments, the computer system is a watch, a phone, a tablet, a fitness tracking device, a processor, a head-mounted display (HMD) device, a communal device, a media device, a speaker, a television, and/or a personal computing device. In some embodiments, the display generation component includes a display screen, a projector, a head mounted display, and/or a touch-sensitive display. In some embodiments, the audio component is a speaker, a smart speaker, a home theater system, a soundbar, a headphone, an earphone, an earbud, a speaker, a television speaker, an augmented reality headset speaker, an audio jack, an optical audio output, a Bluetooth audio output, and/or an HDMI audio output.

The computer system detects (702), via the one or more input devices (e.g., a microphone), an audio input (e.g., 605a) (e.g., a verbal input, a verbal utterance, a sound, an audible request, an audible command, and/or an audible statement) corresponding to (e.g., originating from, originating from a location of, related to, and/or associated with) a subject (e.g., 614) (e.g., a user, a person, an animal, and/or an object). In some embodiments, the audio input is a voice command specific to a user such as “Play my favorite song.” and/or “What meetings do I have scheduled today?”.

In response to (704) detecting the audio input corresponding to the subject, in accordance with a determination that the audio input satisfies a first set of one or more criteria, wherein the first set of one or more criteria includes a criterion that is satisfied when the subject is able to be identified (e.g., using voice recognition technology such as voice biometrics, speaker verification, and/or speaker identification) based on the audio input corresponding to the subject, the computer system outputs (706), via the one or more output devices, a first response (e.g., 606, 606a, and/or audio as described above with respect to FIG. 6C) (e.g., an audio response, a user interface, a notification, text, and/or graphics). In some embodiments, in conjunction with outputting the first response, the computer system performs an operation requested in and/or associated with the audio input corresponding to the subject. In some embodiments, the first response includes an indication of a source (e.g., a speaker) of the audio input. In some embodiments, the first response includes an indication, identification, and/or identity of the subject.

In response to (704) detecting the audio input corresponding to the subject, in accordance with a determination that the audio input satisfies a second set of one or more criteria different from the first set of one or more criteria, wherein the second set of one or more criteria includes a criterion that is satisfied when the subject is not able to be identified based on the audio input corresponding to the subject, the computer system outputs (708), via the one or more output devices, a second response (e.g., 604) (e.g., an audio response, a user interface, a notification, text, and/or graphics) different from the first response. In some embodiments, the second response corresponds to a first disambiguation operation. In some embodiments, the second response includes a request to the subject to repeat the audio input and/or a request the subject to come closer to the computer system. In some embodiments, the second response includes one or more steps for a first disambiguation process such as requesting the subject to repeat the audio input louder and/or faster. In some embodiments, the second response includes one or more steps for a first disambiguation process such as requesting the subject to move toward, further away, and/or closer to the computer system. In some embodiments, in conjunction with outputting the second response, the computer system forgoes performance of an operation requested in and/or associated with the audio input corresponding to the subject. In some embodiments, the second response does not include an indication of a source (e.g., a speaker) of the audio input. In some embodiments, the second response does not include an indication, identification, and/or identity of the subject.

After outputting the second response (e.g., without detecting an input corresponding to the subject since detecting the audio input corresponding to the subject) and in accordance with a determination that the subject is still not able to be identified (and/or in response to detecting the audio input corresponding to the subject), the computer system captures (710) (and/or initiating capture of), via the one or more input devices (e.g., a camera and/or a microphone), media (e.g., an image, a video, and/or an audio recording) of an environment (e.g., a physical environment, space, and/or area) (e.g., as discussed above with respect to FIGS. 6B-6C).

In response to (712) capturing the media of the environment, in accordance with a determination that the media of the environment satisfies a third set of one or more criteria (e.g., the first set of one or more criteria or another set of one or more criteria different from the first set of one or more criteria), wherein the third set of one or more criteria includes a criterion that is satisfied when the subject is able to be identified (e.g., using image recognition such as object recognition, pattern recognition, facial recognition, optical character recognition, scene recognition, edge detection, and/or feature matching) based on the media of the environment (and/or identified based on a combination of the media of the environment and the audio input), the computer system outputs (714), via the one or more output devices, the first response (e.g., 606, 606a, and/or audio as described above with respect to FIG. 6C). In some embodiments, in conjunction with outputting the first response, the computer system performs an operation requested in and/or associated with the audio input corresponding to the subject. In some embodiments, the first response includes an indication of a source (e.g., a speaker) of the audio input. In some embodiments, the first response includes an indication, identification, and/or identity of the subject.

In response to (712) capturing the media of the environment, in accordance with a determination that the media of the environment satisfies a fourth set of one or more criteria (e.g., the second set of one or more criteria or another set of one or more criteria different from the second set of one or more criteria) different from the third set of one or more criteria, wherein the fourth set of criteria includes a criterion that is satisfied when the subject is not able to be identified based on the media of the environment (and/or not able to be identified based on the combination of the media of the environment and the audio input), the computer system forgoes (716) output of (e.g., 604 as descried above with respect to FIG. 6B), via the one or more output devices, the first response. In some embodiments, in conjunction with forgoing output of the first response, the computer system outputs a user interface alerting the subject that an operation corresponding the audio input will not be performed. In some embodiments, in conjunction with forgoing output of the first response, the computer system outputs a user interface requesting that the subject provide identification information. Selectively outputting a response based on a whether a subject is identifiable from media of an environment allows the computer system to accurately execute user specific requests, thereby providing improved feedback to the user and/or performing an operation when a set of conditions has been met without requiring further user input. Selectively outputting a response based on a whether a subject is identifiable from an audio input allows the computer system to cater responses to identified subjects and ensure that subjects are identified before outputting a response, thereby providing improved feedback to the user and/or performing an operation when a set of conditions has been met without requiring further user input. When unable to identify a subject in an environment, outputting an indication of such and capturing media of the environment to identify the subject allows the computer system to resolve subjects that are not able to be identified using output in conjunction with media, thereby providing improved feedback to the user and/or performing an operation when a set of conditions has been met without requiring further user input.

In some embodiments, the first response includes an indication (e.g., as described above with respect to FIG. 6C) (e.g., audio, graphics, texts, and/or images) of (e.g., corresponding to, associated with, and/or related to) the subject (e.g., 614). In some embodiments, before outputting the first response, the computer system receives the indication of the subject from another computer system different from the computer system. In some embodiments, the other computer system corresponds to and/or belongs to the subject, such as a personal device of the subject. In some embodiments, the computer system obtains the indication from the other computer system in response to detecting the audio input corresponding to the subject and in accordance with the determination that the audio input satisfies the first set of one or more criteria. In some embodiments, the computer system obtains the indication from the other computer system in response to capturing the media of the environment and in accordance with the determination that the media of the environment satisfies the third set of one or more criteria. A response including an indication of a subject allows the computer system to indicate to the subject that the subject has been identified and that the response corresponds to the subject, thereby providing improved feedback to the user and/or performing an operation when a set of conditions has been met without requiring further user input.

In some embodiments, the indication of the subject (e.g., 614) includes an identification (e.g., name, a username, a user ID, a token, and/or a digital certification) of the subject registered with the computer system (e.g., 600). In some embodiments, before outputting the first response, the computer system registers the identification of the subject for the subject. In some embodiments, before outputting the first response, the computer system detects, via the one or more input devices, one or more inputs corresponding to a request (e.g., from the subject) to register the identification with the computer system. A response including an identification of a registered subject allows the computer system to indicate to the subject that the subject has been identified and that the response corresponds to the subject, thereby providing improved feedback to the user and/or performing an operation when a set of conditions has been met without requiring further user input.

In some embodiments, the second response (e.g., 604) includes one or more instructions for the subject (e.g., 614) to move closer to the computer system (e.g., 600). In some embodiments, the second response includes one or more instructions for the subject to repeat the audio input. In some embodiments, the second response includes one or more instructions for the subject to repeat the audio input louder, slower, and/or faster. A response including one or more instructions for a subject to move closer to the computer system allows the computer system to instruct what the computer system needs the subject to do for the computer system to be able to identify the subject, thereby providing improved feedback to the user and/or performing an operation when a set of conditions has been met without requiring further user input.

In some embodiments, capturing (e.g., as described above with respect to FIGS. 6B-6C) the media of the environment occurs automatically after a predetermined period of time after outputting the second response (e.g., 604). In some embodiments, capturing the media of the environment occurs in conjunction with (e.g., before, while, after, and/or in response to and/or in accordance with a determination that the predetermined period of time has expired since outputting the second response) outputting the second response. Automatically capturing media of an environment after outputting a response allows the computer system to attempt to identify a subject via the media when the subject is not able to be identified, thereby providing improved feedback to the user and/or performing an operation when a set of conditions has been met without requiring further user input.

In some embodiments, the media of the environment is first media. In some embodiments, at a first time after outputting the second response, wherein the first media is captured at a second time different from (e.g., before or after) the first time, in accordance with a determination that the subject (e.g., 614) is within a field of view of the one or more input devices (e.g., as illustrated in FIG. 6C by 614 being within the field of view), the computer system captures (e.g., as described above with respect to FIGS. 6B-6C), via the one or more input devices, second media of the environment, wherein the second media is separate from the first media. In some embodiments, the second media is captured without capturing the first media. In some embodiments, at the first time after outputting the second response, wherein the first media is captured at the second time different from the first time, in accordance with a determination that the subject is not within the field of view of the one or more input devices, the computer system forgoes capture of (e.g., as described above with respect to FIGS. 6B-6C), via the one or more input devices, the second media of the environment. In some embodiments, the determination that the subject is within the field of view of the one or more input devices is based on a determined direction of the audio input. In some embodiments, the determination that the subject is within the field of view of the one or more input devices is based on the first media (e.g., whether the subject is identified in the first media and/or in the field of view in the first media). Selectively capturing media of an environment based on whether a subject is within a field of view allows the computer system to minimize a number of unnecessary media captures, thereby providing improved feedback to the user and/or performing an operation when a set of conditions has been met without requiring further user input.

In some embodiments, the one or more output devices includes one or more display generation components (e.g., a display screen, a projector, a head mounted display, and/or a touch-sensitive display). In some embodiments, while detecting the audio input corresponding to the subject (e.g., 614), the computer system displays, via the one or more display generation components, first content (e.g., 602) (e.g., a user interface element, a virtual button, a graphic, an icon, a widget, a control, lock screen and/or a window of an application), wherein outputting the first response (e.g., 606, 606a, and/or audio as discussed above with respect to FIG. 6C) includes displaying, via the one or more display generation components, second content different from the first content (e.g., with or without displaying the first content). In some embodiments, the second content is not displayed before detecting the audio input corresponding to the subject. In some embodiments, the second content is a response to the audio input, such as a response received from an application of the computer system and/or another computer system different from the computer system. Displaying content when outputting a response to an audio input once a subject has been identified allows the computer system to provide the response in a visual manner that, in some embodiments, includes data corresponding to the subject, thereby providing improved feedback to the user and/or performing an operation when a set of conditions has been met without requiring further user input.

In some embodiments, the one or more output devices includes one or more display generation components (e.g., a display screen, a projector, a head mounted display, and/or a touch-sensitive display). In some embodiments, while detecting the audio input corresponding to the subject (e.g., 614), the computer system displays, via the one or more display generation components, first content (e.g., 602) (e.g., a user interface element, a virtual button, a graphic, an icon, a widget, a control, and/or a window of an application), wherein outputting the second response (e.g., 606, 606a, and/or audio as discussed above with respect to FIG. 6C) includes displaying, via the one or more display generation components, third content different from the first content (e.g., with or without displaying the first content). In some embodiments, the third content is not displayed before detecting the audio input corresponding to the subject. In some embodiments, the third content is a response to the audio input, such as a response received from an application of the computer system and/or another computer system different from the computer system. Displaying content when outputting a response to an audio input when a subject has not been identified allows the computer system to indicate to the subject that the subject is not able be identified and/or that a requested operation is not able to be executed until the subject has been identified, thereby providing improved feedback to the user and/or performing an operation when a set of conditions has been met without requiring further user input.

In some embodiments, in response to detecting the audio input (e.g., 605a) corresponding to the subject (e.g., 614) and in accordance with the determination that the audio input satisfies the second set of one or more criteria, the computer system forgoes output of (e.g., as described above with respect to FIG. 6B), via the one or more output devices, the first response. Forgoing output of a response to an audio input when a subject is not able to be identified allows the computer system to wait until the subject is identified before performing an operation corresponding to the audio input, thereby providing improved feedback to the user and/or performing an operation when a set of conditions has been met without requiring further user input.

In some embodiments, outputting the second response (e.g., 604) includes outputting, via the one or more output devices, an indication (e.g., audio, graphic, text, and/or image) that the subject (e.g., 614) cannot be identified (e.g., is unidentifiable, is not identified, and/or is currently unidentified). Outputting an indication that a subject cannot be identified based on an audio input allows the computer system to alert the subject when a requested operation cannot be executed, thereby providing improved feedback to the user and/or performing an operation when a set of conditions has been met without requiring further user input.

In some embodiments, outputting the second response (e.g., 604) includes outputting, via the one or more output devices, one or more instructions for the subject (e.g., 614) to repeat the audio input corresponding to the subject. Outputting one or more instructions for a subject to repeat an audio input when the subject is not able to be identified by the audio input allows the computer system to indicate when an operation is not able to be performed and how the subject can rectify this issue, thereby providing improved feedback to the user and/or performing an operation when a set of conditions has been met without requiring further user input.

In some embodiments, outputting the second response (e.g., 604) includes outputting, via the one or more output devices, one or more instructions for the subject (e.g., 614) to speak louder. In some embodiments, outputting the second response includes outputting, via the one or more output devices, one or more instructions for the subject to repeat the audio input corresponding to the subject louder. In some embodiments, outputting the second response includes outputting, via the one or more output devices, one or more instructions for the subject to direct themselves toward the computer system. Outputting one or more instructions for a subject to speak louder when the subject is not able to be identified by the audio input allows the computer system to indicate when an operation is not able to be performed and how the subject can rectify this issue, thereby providing improved feedback to the user and/or performing an operation when a set of conditions has been met without requiring further user input.

In some embodiments, outputting the second response (e.g., 604) includes outputting, via the one or more output devices, one or more instructions for the subject (e.g., 614) to decrease sound in the environment. In some embodiments, outputting the second response includes outputting, via the one or more output devices, one or more instructions for the subject to repeat the audio input corresponding to the subject after decreasing the sound in the environment. In some embodiments, outputting the second response includes outputting, via the one or more output devices, a question whether the computer system should reduce a volume of audio content being output by the computer system. In some embodiments, outputting the second response includes displaying, via the one or more display generation components, a user interface element for decreasing a volume of content output by the computer system. In some embodiments, while displaying the user interface element for decreasing the volume of content output by the computer system, the computer system detects, via the one or more input devices, an input (e.g., a selection input, such a tap input) corresponding to the user interface element for decreasing the volume of content output by the computer system. In some embodiments, in response to detecting the input corresponding to the user interface element for decreasing the volume of content output by the computer system, the computer system decreases, via the one or more output devices, the volume of content output by the computer system. Outputting one or more instructions for a subject to decrease sound in an environment when the subject is not able to be identified by the audio input allows the computer system to indicate when an operation is not able to be performed and how the subject can rectify this issue, thereby providing improved feedback to the user and/or performing an operation when a set of conditions has been met without requiring further user input.

In some embodiments, the criterion that is satisfied when the subject (e.g., 614) is able to be identified based on the media of the environment includes a criterion that the subject is captured in the media of the environment (e.g., the subject is present in an image). Identifying a subject based on media of an environment allows the computer system to authenticate a subject before executing a requested operation by the subject, thereby providing improved feedback to the user and/or performing an operation when a set of conditions has been met without requiring further user input.

In some embodiments, after capturing (e.g., as described with respect to FIGS. 6B-6C) the media of the environment, the computer system deletes the media of the environment (e.g., after and/or in response to a predetermined period of time lapses, the determination that the third set of one or more criteria is performed, and/or the determination that the fourth set of one or more criteria is performed). In some embodiments, the media of the environment is not deleted and the media of the environment is used to determine and/or confirm the identity of the subject at a future time. Deleting media of an environment after using the media to identify a subject allows the computer system to maintain user privacy by deleting personal data after the data is no longer needed, thereby providing improved feedback to the user, performing an operation when a set of conditions has been met without requiring further user input and/or increasing security of the computer system.

In some embodiments, the audio input (e.g., 605a) corresponding to the subject is output (e.g., spoken and/or said) by the subject. Audio input being output by a subject allows the computer system to authenticate the subject based on biometric data, thereby providing improved feedback to the user, performing an operation when a set of conditions has been met without requiring further user input and/or increasing security of the computer system.

In some embodiments, the one or more output devices includes one or more display generation components and one or audio generation components. In some embodiments, outputting the second response (e.g., 604) includes displaying, via the one or more display generation components, visual content (e.g., corresponding to (e.g., associated with and/or related to) the second response) and outputting, via the one or more audio generation components, audio content (e.g., corresponding to (e.g., associated with and/or related to) the second response). Outputting visual and audio content in response to an audio input allows the computer system to provide a subject with visual and auditory notifications regarding a status of a requested operation, thereby providing improved feedback to the user and/or performing an operation when a set of conditions has been met without requiring further user input.

In some embodiments, the one or more output devices includes one or audio generation components. In some embodiments, while detecting the audio input corresponding to the subject, the computer system outputs (e.g., as described with respect to FIG. 6B), via the one or more audio generation components, a first audio content. In some embodiments, in response to detecting the audio input corresponding to the subject, the computer system suspends (e.g., as described with respect to FIG. 6B) (e.g., ceases and/or pauses) output of the first audio content. In some embodiments, the computer system suspends the output of the first audio content and then outputs the first response. In some embodiments, the computer system suspends the output of the first audio content and then outputs the second response. In some embodiments, the computer system suspends the output of the first audio content at a predetermined of time before outputting the first response. In some embodiments, the computer system suspends the output of the first audio content at a predetermined of time before outputting the second response. In some embodiments, the computer system continues output of the first audio content after output of the first response. In some embodiments, the computer system continues output of the first audio content after output of the second response. Suspending output of audio content in response to detecting an audio input allows the computer system to emphasize the computer system's response to a user request, thereby providing improved feedback to the user and/or performing an operation when a set of conditions has been met without requiring further user input.

In some embodiments, the one or more output devices includes one or more audio generation components. In some embodiments, while detecting the audio input (e.g., 605a) corresponding to the subject (e.g., 614), the computer system outputs, via the one or more audio generation components, a first audio content in at least a first direction and a second direction different from the first direction, wherein the first response is output in the first direction (e.g., a direction corresponding to a direction of the subject relative to the one or more output devices) without being output in the second direction, and wherein the second response is output in the first direction without being output in the second direction. In some embodiments, the first audio content continues to be output in the second direction while the first response and/or the second response is output. In some embodiments, the first audio content ceases to be output in the second direction while the first response and/or the second response is output. In some embodiments, the first audio content continues to be output in the first direction while the first response and/or the second response is output. Outputting a response to an audio input in a narrower area than audio content being output while detecting the audio input allows the computer system to target the response toward a subject rather than throughout an environment, thereby providing improved feedback to the user and/or performing an operation when a set of conditions has been met without requiring further user input.

In some embodiments, in conjunction with (e.g., before and/or while) capturing (e.g., as described with respect to FIG. 6B) the media of the environment, the computer system outputs, via the one or more output devices, an indication (e.g., a light, audio, graphic, text, and/or user interface) that the one or more input devices is in an active state (and/or standby state). Outputting an indication that an input device is in an active state allows the computer system to notify a subject of a current status of the input device, thereby providing improved privacy, providing improved feedback to the user, and/or performing an operation when a set of conditions has been met without requiring further user input.

In some embodiments, a criterion of the first set of one or more criteria (and/or the third set of one or more criteria) that is satisfied when the subject (e.g., 614) is able to be identified includes a determination that the audio input (e.g., 605a) (and/or media of the environment) corresponds to a known profile (e.g., an account, a user profile, and/or a user account) of the subject (e.g., the subject is recognized by the first computer system, the first computer system has access to information relating to the subject, the first computer system is registered with an account of the subject, the first computer system has access to information regarding biometrics of the subject, and/or the subject has previously interacted with and/or used the first computer system). In some embodiments, a criterion of the second set of one or more criteria that is satisfied when the subject is not able to be identified based on the audio input includes a determination that the audio input does not correspond to a known profile of the subject (e.g., the audio input and/or the subject is not recognized by the first computer system, the first computer system does not have access to information relating to the subject, the first computer system is not registered with an account of the subject, the first computer system does not have access to information regarding biometrics of the subject, and/or the subject has not previously interacted with and/or used the first computer system). In some embodiments, in response to detecting the audio input corresponding to the subject and in accordance with a determination that the subject corresponds to a known profile (e.g., the audio input corresponding to the subject is matches with a profile (e.g., a profile that includes the subject biometrics of the subject including a voice profile) of the subject), the computer system outputs, via one or more output devices, the first response. In some embodiments, in response to capturing the media of the environment and in accordance with a determination that the subject the media of the environment matches a profile of the subject (a profile that include user biometrics such as facial identification), the computer system output, via one or more output devices, the first response. Identifying a subject based on an audio input corresponding to a known profile of the subject allows the computer system to authenticate the subject using voice biometrics before executing a requested operation by the subject, thereby providing improved feedback to the user and/or performing an operation when a set of conditions has been met without requiring further user input.

In some embodiments, in response to detecting the audio input (e.g., 605a) corresponding to the subject (e.g., 614) and in accordance with the determination that the audio input satisfies the first set of one or more criteria (and/or in conjunction with (e.g., before, after, in response to, and/or while) outputting the first response), the computer system activates e.g., displays content corresponding to the known profile of the subject) the known profile of the subject (and/or deactivates another profile different from the known profile of the subject and/or operates with respect to the known profile of the subject, such as without operating with respect to another profile different from the known profile). In some embodiments, activating the known profile includes providing an output via one or more output devices (e.g., displaying via the one or more display generation components) based on one or more features of the known profile. In some embodiments, activating the known profile includes outputting (e.g., displaying via the one or more display generation components) an indication of (1) activation of and/or (2) the known profile (e.g., with a representation of the known profile). In some embodiments, in response to (e.g., in conjunction with and/or while) detecting the audio input (that corresponds to the request to operate with the subject profile) and in accordance with a determination that the second set of one or more criteria and/or the fourth set of one or more criteria is satisfied, the first computer system ceases and/or forgoes activation of the known profile corresponding to the subject. Activating a known profile of a subject after identifying the subject based on an audio input corresponding to the known profile of the subject allows the computer system to operate with the known profile while executing a requested operation by the subject, thereby providing improved feedback to the user and/or performing an operation when a set of conditions has been met without requiring further user input.

In some embodiments, in response to detecting the audio input (e.g., 605a) corresponding to the subject (e.g., 614) and in accordance with the determination that the audio input satisfies the second set of one or more criteria (and/or in conjunction with (e.g., before, after, in response to, and/or while) forgoing output of the first response), the computer system initiates (and/or causes initiation of) a security protocol (e.g., authentication, confirmation and/or user verification, such as via the first computer system and/or a second computer system (e.g., a watch, a phone, a tablet, a fitness tracking device, a processor, a head-mounted display (HMD) device, a communal device, a media device, a speaker, a television, an electronic device, and/or a personal computing device) external to (and/or different from) the first computer system) corresponding to (e.g., for and/or on behalf of) the subject (e.g., as described with respect to FIG. 6B). In some embodiments, the known profile corresponding to the subject is active on the first computer system after (e.g., in response to) the security protocol (e.g., on the second computer system) is successfully performed. In some embodiments, initiating the security protocol includes requesting (e.g., outputting a request) a set of one or more credentials (e.g., username, password, passcode, and/or authorization) from the subject. In some embodiments, initiating the security protocol includes requesting biometric information (e.g., fingerprint and/or facial identification) from the subject. Initiating a security protocol when a subject is not able to be identified allows the computer system to resolve subjects that are not able to be identified, thereby providing improved feedback to the user and/or performing an operation when a set of conditions has been met without requiring further user input.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the audio input of process 700 can be the input of process 800. For brevity, these details are not repeated herein.

FIG. 8 is a flow diagram illustrating a process (e.g., process 800) for performing an operation based on an ambiguous request related to displayed content in accordance with some embodiments. Some operations in process 800 are, optionally, combined, the orders of some operations are, optionally, changed, and some operations are, optionally, omitted.

As described below, process 800 provides an intuitive way for performing an operation based an ambiguous request related to displayed content. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the audio component includes a speaker, a smart speaker, a home theater system, a soundbar, a headphone, an earphone, an earbud, a speaker, a television speaker, an augmented reality headset speaker, an audio jack, an optical audio output, a Bluetooth audio output, and/or an HDMI audio output.

While displaying, via the one or more display generation components, a first user interface object (e.g., 608a, 608b, 608c, 620a, 620b, 620c, 620d, 620e, 620f, 626a, 626b, 626c, or 626d) (e.g., graphic image, an icon, a widget, a control, and/or a window) (e.g., within a user interface) with a first set of one or more visual characteristics (e.g., as described above with respect to FIGS. 6D-6I) (e.g., color, size, shape, pattern, texture, depth, distance and/or location) and a second user interface object (e.g., 608a, 608b, 608c, 620a, 620b, 620c, 620d, 620e, 620f, 626a, 626b, 626c, or 626d) (e.g., graphic image, an icon, a widget, a control, and/or a window) (e.g., within the user interface) with a second set of one or more visual characteristics (e.g., as described above with respect to FIGS. 6D-6I) (e.g., color, size, shape, pattern, texture, depth, distance and/or location) different from the first set of one or more visual characteristics, the computer system detects (802), via the one or more input device, an input (e.g., 605d, 605f, or 605h) (e.g., a verbal input and/or a non-verbal input) that includes an identification of (and/or a reference to) a first visual characteristic (e.g., as described above with respect to FIGS. 6D-6I) (e.g., color, size, shape, pattern, texture, depth, distance and/or location), wherein the second user interface object is different from the first user interface object. In some embodiments, a verbal input includes a verbal utterance, a sound, an audible request, an audible command, and/or an audible statement. In some embodiments, a non-verbal includes a tap input, a selection input, a swipe input, a hold-and-drag input, a gaze input, an air gesture, mouse movement, and/or a mouse click. In some embodiments, the first set of one or more characteristics and the second set of one or more characteristics share and/or include some common features. In some embodiments, the input includes an operation request (e.g., open an application, play a song, and/or set an alarm) and a first visual characteristic.

In response to (804) detecting the input (e.g., 605d, 605f, or 605h) that includes the identification of the first visual characteristic (e.g., as described above with respect to FIGS. 6D-6I), in accordance with a determination that a first set of one or more criteria is satisfied, wherein the first set of one or more criteria includes a criterion that is satisfied when the first visual characteristic corresponds to (e.g., relates to, is found in, and/or is associated with) the first set of one or more visual characteristics, the computer system performs (806) an operation (e.g., 616, 622a, or 628 as described above with respect to FIGS. 6D-6I) (e.g., plays video, plays audio, displays an image, retrieves a document, opens a webpage, and/or initiates an application) corresponding to (e.g., related to and/or associated with) the first user interface object (e.g., and not the second user interface object). In some embodiments, the first visual characteristic corresponds to the first set of one or more visual characteristics when the first user interface object includes more of the first visual characteristic than the second user interface object. In some embodiments, the first visual characteristic corresponds to the first set of one or more visual characteristics when the first user interface object includes the first visual characteristic and the second user interface object does not include the first visual characteristic. In some embodiments, the first visual characteristic corresponds to the first set of one or more visual characteristics when an amount of the first visual characteristic in the first user interface object exceeds a threshold (e.g., 25%-99%).

In response to (804) detecting the input that includes the identification of the first visual characteristic, in accordance with a determination that a second set of one or more criteria, different from the first set of one or more criteria, is satisfied, wherein the second set of one or more criteria includes a criterion that is satisfied when the first visual characteristic corresponds to (e.g., relates to, is found in, and/or is associated with) the second set of one or more visual characteristics, the computer system performs (808) an operation (e.g., as described above with respect of FIGS. 6D-6I) (e.g., plays video, plays audio, displays an image, retrieves a document, opens a webpage, and/or initiates an application) corresponding to (e.g., related to and/or associated with) the second user interface object (e.g., and not the first user interface object). Performing an operation corresponding to a first user interface object or a second user interface object based on a visual characteristic in a request and identification of the visual characteristic in the first user interface object or the second user interface object allows the computer system to respond to non-specific (and/or vague) user requests, thereby providing improved feedback to the user and/or performing an operation when a set of conditions has been met without requiring further user input.

In some embodiments, the first visual characteristic (e.g., as described above with respect to FIGS. 6D-6I) (e.g., from the audio input) includes (and/or is) a general (e.g., common, broad, imprecise, inexact, approximate, nonspecific, and/or vague) visual characteristic (e.g., circular, the color red, and/or a big animal). In some embodiments, the first set of one or more visual characteristics includes a visual characteristic that is a first variation (e.g., a circle, light red, and/or an elephant) of the general visual characteristic. In some embodiments, the second set of one or more visual characteristics includes a visual characteristic that is a second variation (e.g., an ellipse, lighter red than the light red, and/or a mouse) of the general visual characteristic. In some embodiments, the second variation is different from the first variation. In some embodiments, the criterion that is satisfied when the first visual characteristic corresponds to the first set of one or more visual characteristics is satisfied when the general visual characteristic is determined to correspond to the first variation more than the second variation (e.g., the circle is more circular than the ellipse, the lighter red is more red than the light red, and/or the elephant is a bigger animal than the mouse). In some embodiments, the criterion that is satisfied when the first visual characteristic corresponds to the second set of one or more visual characteristics is satisfied when the general visual characteristic is determined to correspond to the second variation more than the first variation. In some embodiments, the first visual characteristic is a size. In such embodiments, the first visual characteristic corresponds to the first set of one or more visual characteristics instead of the second set of one or more visual characteristics when the first user interface object is bigger than the second user interface object. In some embodiments, the first visual characteristic is a shape. In such embodiments, the first visual characteristic corresponds to the first set of one or more visual characteristics instead of the second set of one or more visual characteristics when the first user interface object is closer to and/or includes more of the shape than the second user interface object. In some embodiments, the first visual characteristic is a color. In such embodiments, the first visual characteristic corresponds to the first set of one or more visual characteristics instead of the second set of one or more visual characteristics when the first user interface object is closer to and/or includes more of the color than the second user interface object. In some embodiments, the first visual characteristic is a type of object. In such embodiments, the first visual characteristic corresponds to the first set of one or more visual characteristics instead of the second set of one or more visual characteristics when the first user interface object is closer to and/or includes more of the type of object than the second user interface object. In some embodiments, the first visual attribute is a common visual attribute between the first user interface object and the second user interface object. In some embodiments, the first set of one or more visual characteristics includes a visual characteristic that is a first variation of the common visual attribute. In some embodiments, the second set of one or more visual characteristics includes a visual characteristic that is a second variation of the common visual attribute. In some embodiments, the second variation is different from the first variation. In some embodiments, the first set of one or more visual characteristics includes a characteristic that is a different variation than a characteristic of the second set of one or more visual characteristics. In some embodiments, the first set of one or more visual characteristics and the second set of one or more visual characteristics correspond to (e.g., relate to, associated with, and/or belong to) an attribute (and/or a type of visual characteristic such as size, color, typography, content, and/or position) shared between the first user interface object and the second user interface object. In some embodiments, the general visual characteristic is determined to correspond to the first variation more than the second variation by a value being assigned to each of the first visual characteristic, the first variation, and the second variation and the values being compared to identify whether the value for the first variation or the value for the second variation is closer to the value for the first visual characteristic. Distinguishing between variations of a general characteristic to determine which operation to perform allows the computer system to respond to a non-specific (and/or vague) user request, thereby providing improved feedback to the user and/or performing an operation when a set of conditions has been met without requiring further user input.

In some embodiments, the first user interface object (e.g., 608a, 608b, 608c, 620a, 620b, 620c, 620d, 620e, 620f, 626a, 626b, 626c, or 626d) is a first type of user interface object (e.g., an image, a video, a foreground, a background, a widget, a size of a user interface object, a shape of a user interface object, an icon, a shortcut, a control, and/or a link). In some embodiments, the second interface object (e.g., 608a, 608b, 608c, 620a, 620b, 620c, 620d, 620e, 620f, 626a, 626b, 626c, or 626d) is the first type of user interface object. In some embodiments, the first user interface object and the second interface object are shortcuts to different files that are executable by the same application. In some embodiments, the first user interface object and the second interface object are shortcuts to files that are executable by different applications. Distinguishing between user interface objects of the same type to determine which operation to perform allows the computer system to respond to a non-specific (and/or vague) user request, thereby providing improved feedback to the user and/or performing an operation when a set of conditions has been met without requiring further user input.

In some embodiments, the first visual characteristic (e.g., as described above with respect to FIGS. 6D-6I) corresponds to the first set of one or more visual characteristics when the first visual characteristic has a greater degree of relatedness (e.g., as described with respect to FIGS. 6D-6I) (e.g., similarity, correlation, and/or connection) with the first set of one or more visual characteristics than the first visual characteristic with the second set of or more visual characteristics. In some embodiments, the first visual characteristic corresponds to the second set of one or more visual characteristics when the first visual characteristic has a greater degree of relatedness (e.g., similarity, correlation, and/or connection) with the second set of one or more visual characteristics than the first visual characteristic with the first set of or more visual characteristics. A visual characteristic corresponding to either a first set of visual characteristics or a second set of visual characteristics based on which set of visual characteristics has a greater degree of relatedness with a requested visual characteristic allows the computer system to respond to a non-specific (and/or vague) user request, thereby providing improved feedback to the user and/or performing an operation when a set of conditions has been met without requiring further user input.

In some embodiments, the first visual characteristic (e.g., as described above with respect to FIGS. 6D-6I) corresponds to the first set of one or more visual characteristics when an amount (e.g., a portion, a size, and/or an area) of a visual characteristic of the first set of one or more visual characteristics that corresponds to (e.g., related to, associated with, and/or has a predetermined degree of relatedness to) the first visual characteristic is greater than an amount (e.g., a portion, a size, and/or an area) of a visual characteristic of the second set of one or more visual characteristics that corresponds to (e.g., related to, associated with, and/or has a predetermined degree of relatedness to) the first visual characteristic. In some embodiments, the first visual characteristic corresponds to the second set of one or more visual characteristics when the amount of the visual characteristic of the second set of one or more visual characteristics that corresponds to the first visual characteristic is greater than the amount of the visual characteristic of the first set of one or more visual characteristics that corresponds to the first visual characteristic. A visual characteristic corresponding to either a first set of visual characteristics or a second set of visual characteristics based on which set of visual characteristics has a greater amount of the requested visual characteristic allows the computer system to respond to a non-specific (and/or vague) request, thereby providing improved feedback to the user and/or performing an operation when a set of conditions has been met without requiring further user input.

In some embodiments, in response to detecting the input (e.g., 605d, 605f, or 605h) that includes the identification of the first visual characteristic (e.g., as described above with respect to FIGS. 6D-6I) and in accordance with a determination that a third set of one or more criteria, different from the first set of one or more criteria and the second set of one or more criteria, is satisfied (e.g., that the first visual characteristic does not correspond to a user interface object that is currently displayed), wherein the third set of one or more criteria includes a first criterion that is satisfied when the first visual characteristic does not correspond to (e.g., related to, associated with, and/or has a predetermined degree of relatedness to) the first set of one or more visual characteristics, wherein the third set of one or more criteria includes a second criterion that is satisfied when the first visual characteristic does not correspond to (e.g., related to, associated with, and/or has a predetermined degree of relatedness to) the second set of one or more visual characteristics, the computer system forgoes performance of the operation (e.g., as described above with respect to FIGS. 6D-6I) (e.g., corresponding to the first user interface object and/or the first user interface object). Forgoing performance of an operation based on a requested visual characteristic not corresponding to either a first set of visual characteristics or a second set of visual characteristics allows the computer system to prevent from incorrectly executing an operation in response to a non-specific (and/or vague) user request, thereby providing improved feedback to the user and/or performing an operation when a set of conditions has been met without requiring further user input.

In some embodiments, while displaying the first user interface object (e.g., 608a, 608b, 608c, 620a, 620b, 620c, 620d, 620e, 620f, 626a, 626b, 626c, or 626d) with the first set of one or more visual characteristics and the second user interface object (e.g., 608a, 608b, 608c, 620a, 620b, 620c, 620d, 620e, 620f, 626a, 626b, 626c, or 626d) with the second set of one or more visual characteristics, the computer system detects, via the one or more input device, a selection input (e.g., a tap input and/or a voice input) different from the input that includes the identification of the first visual characteristic. In some embodiments, the selection include does not include the identification of the first visual characteristic. In some embodiments, in response to detecting the selection input, in accordance with a determination that the selection input corresponds to (e.g., directed to, at a location of, related to, and/or associated with) the first interface object, the computer system performs the operation that corresponds to the first user interface object. In some embodiments, in response to detecting the selection input, in accordance with a determination that the second input corresponds to (e.g., directed to, at a location of, related to, and/or associated with) the second interface object, the computer system performs the operation that corresponds to the second user interface object. Performing an operation corresponding to either a first user interface object or a second user interface object based on either an ambiguous request or a selection input directed to the first user interface object or the second user interface object allows the computer system to enable different manners for selecting user interface objects, thereby providing improved feedback to the user and/or performing an operation when a set of conditions has been met without requiring further user input.

In some embodiments, the operation corresponding to the first user interface object (e.g., 608a, 608b, 608c, 620a, 620b, 620c, 620d, 620e, 620f, 626a, 626b, 626c, or 626d) is a first type of operation (e.g., as described above with respect to FIGS. 6D-6I) (e.g., executing a specific task, launching an application, and/or terminating an application that is performed differently depending on which user interface object is selected and/or which information that the operation is performed based on). In some embodiments, the operation corresponding to the second user interface object is the first type of operation (e.g., as described with respect to FIGS. 6D-6I). Distinguishing between operations of the same type using visual characteristics of user interface objects allows the computer system to respond to a non-specific (and/or vague) user request, thereby providing improved feedback to the user and/or performing an operation when a set of conditions has been met without requiring further user input.

In some embodiments, performing the operation corresponding to the first user interface object includes displaying, via the one or more displaying generation components, first content (e.g., 616, 622a, or 628) (e.g., an indication that the operation is being performed, a user interface corresponding to performing the operation, an image, a video, a movie, a tv show, a music video, a personal video, and/or a photo). In some embodiments, performing the operation corresponding to the second user interface object includes displaying, via the one or more displaying generation components, second content (e.g., without displaying the first content) different from the first content (e.g., as described above with respect to FIGS. 6D-6I). Displaying either a first or second content when performing an operation corresponding to a first user interface object or a second user interface object based on a requested visual characteristic corresponding to the first user interface object or the second user interface object allows the computer system to respond differently when different operations are performed via a non-specific (and/or vague) user request, thereby providing improved feedback to the user and/or performing an operation when a set of conditions has been met without requiring further user input.

In some embodiments, the computer system (e.g., 600) is in communication with one or more audio generation components. In some embodiments, performing the operation corresponding to the first user interface object (e.g., 608a, 608b, 608c, 620a, 620b, 620c, 620d, 620e, 620f, 626a, 626b, 626c, or 626d) includes outputting, via the one or more audio generation components, first audio content (e.g., corresponding to the first user interface object) (e.g., as described above with respect to FIGS. 6D-6I). In some embodiments, the first audio content or the second audio content includes a sound, one or more words, a recording, a podcast, a song, and/or movie audio. In some embodiments, performing the operation corresponding to the second user interface object (e.g., 608a, 608b, 608c, 620a, 620b, 620c, 620d, 620e, 620f, 626a, 626b, 626c, or 626d) includes outputting, via one or more audio generation components, second audio content (e.g., corresponding to the second user interface object) different from the first audio content (e.g., as described above with respect to FIGS. 6D-6I). Outputting audio content corresponding to a user interface object in response to an audio input allows the computer system to respond to the audio input with audio content, thereby providing improved feedback to the user and/or performing an operation when a set of conditions has been met without requiring further user input.

In some embodiments, the input that includes the identification of the first visual characteristic is a first input. In some embodiments, while performing the operation corresponding to the first user interface object (e.g., 608a, 608b, 608c, 620a, 620b, 620c, 620d, 620e, 620f, 626a, 626b, 626c, or 626d), the computer system detects, via the one or more input devices, a second input (e.g., a tap input and/or a voice input) different from first input. In some embodiments, in response to detecting the second input, the computer system ceases performance of the operation corresponding to the first user interface object (e.g., as described above with respect to FIGS. 6D-6I). In some embodiments, in response to detecting the second input, the computer system performs an operation corresponding to the second input. In some embodiments, after and/or in response to finishing performance of the operation corresponding to the second input, the computer system restarts and/or continues performance of the operation corresponding to the first user interface object. In some embodiments, while performing the operation corresponding to the second user interface object, the computer system detects, via the one or more input devices, another input (e.g., a tap input and/or a voice input) different from first input. In some embodiments, in response to detecting the second input, the computer system ceases performance of the operation corresponding to the second user interface object. In some embodiments, in response to detecting the other input, the computer system performs an operation corresponding to the other input. In some embodiments, after and/or in response to finishing performance of the operation corresponding to the other input, the computer system restarts and/or continues performance of the operation corresponding to the second user interface object. Ceasing performance of an operation corresponding to a user interface object in response to detecting an input allows the computer system to provide a user with the ability to stop execution of an ongoing operation, thereby providing improved feedback to the user and/or performing an operation when a set of conditions has been met without requiring further user input.

In some embodiments, in response to detecting the input that includes the identification of the first visual characteristic and in accordance with the determination that the first set of one or more criteria is satisfied, the computer system forgoes performance of the operation corresponding to the second user interface object (e.g., as described above with respect to FIGS. 6D-6I). In some embodiments, in response to detecting the input that includes the identification of the first visual characteristic and in accordance with the determination that the second set of one or more criteria is satisfied, the computer system forgoes performance of the operation corresponding to the first user interface object. Forgoing performance of an operation corresponding a second user interface object while performing an operation corresponding to the first user interface object allows the computer system to respond to a non-specific (and/or vague) user request without performing unwanted operations, thereby providing improved feedback to the user and/or performing an operation when a set of conditions has been met without requiring further user input.

In some embodiments, performing the operation corresponding to the first user interface object (e.g., 608a, 608b, 608c, 620a, 620b, 620c, 620d, 620e, 620f, 626a, 626b, 626c, or 626d) includes displaying, via the one or more display generation components, the first user interface object with a third set of one or more visual characteristics different from the first set of one or more visual characteristics (e.g., as described above with respect to FIGS. 6D-6I). In some embodiments, before displaying the first user interface object with the third set of one or more visual characteristics, in response to detecting the input that includes the identification of the first visual characteristic, and in accordance with the determination that the first set of one or more criteria is satisfied, the computer system displays, via the one or more display generation components, a transition animation from the first set of one or more visual characteristics to the third set one or more visual characteristics. In some embodiments, performing the operation corresponding to the second user interface object includes displaying, via the one or more display generation components, the second user interface object with another set of one or more visual characteristics different from the second set of one or more visual characteristics. Modifying an appearance of a user interface object allows the computer system to alert a user that an operation is currently being performed, thereby providing improved feedback to the user and/or performing an operation when a set of conditions has been met without requiring further user input.

In some embodiments, while performing the operation corresponding to the first user interface (e.g., 608, 620, or 626) (and/or in response to detecting the input that includes the identification of the first visual characteristic and in accordance with the determination that the first set of one or more criteria is satisfied), the computer system ceases display of (e.g., as described above with respect to FIGS. 6D-6I), via the one or more display generation components, the second user interface object (e.g., 608a, 608b, 608c, 620a, 620b, 620c, 620d, 620e, 620f, 626a, 626b, 626c, or 626d). Ceasing display of a second user interface object while performing an operation corresponding to a first user interface allows the computer system to alert a user of the operation currently being executed, thereby providing improved feedback to the user and/or performing an operation when a set of conditions has been met without requiring further user input.

In some embodiments, after performing the operation corresponding to the first user interface object (e.g., 608a, 608b, 608c, 620a, 620b, 620c, 620d, 620e, 620f, 626a, 626b, 626c, or 626d), the computer system displays (and/or redisplays), via the one or more display generation components, the second user interface object (e.g., 608a, 608b, 608c, 620a, 620b, 620c, 620d, 620e, 620f, 626a, 626b, 626c, or 626d). After ceasing display of a second user interface object and performing an operation corresponding to a first user interface object, displaying the second user interface object allows the computer system to provide a user with previously provided content that was not previously selected, thereby providing improved feedback to the user and/or performing an operation when a set of conditions has been met without requiring further user input.

In some embodiments, the first set of one or more visual characteristics (e.g., size, color, and/or shape) and the second set of one or more visual characteristics (e.g., size, color, and/or shape) are the same type of visual characteristic (e.g., as described above with respect to FIGS. 6D-6I) (e.g., size, color, and/or shape). Distinguishing between user interface objects based on visual characteristics of the same type to determine which operation to perform allows the computer system to respond to a non-specific (and/or vague) user request, thereby providing improved feedback to the user and/or performing an operation when a set of conditions has been met without requiring further user input.

In some embodiments, while performing the operation corresponding to the first user interface (e.g., 608, 620, or 626), the computer system ceases display of the second user interface object (e.g., 608a, 608b, 608c, 620a, 620b, 620c, 620d, 620e, 620f, 626a, 626b, 626c, or 626d) while maintaining display of the first user interface object (e.g., 608a, 608b, 608c, 620a, 620b, 620c, 620d, 620e, 620f, 626a, 626b, 626c, or 626d). Ceasing display of a second user interface object while maintaining display of a first user interface object and performing an operation corresponding to the first user interface object allows the computer system to alert a user of the operation currently being executed, thereby providing improved feedback to the user and/or performing an operation when a set of conditions has been met without requiring further user input.

Note that details of the processes described above with respect to process 800 (e.g., FIG. 8) are also applicable in an analogous manner to the processes described herein. For example, process 700 optionally includes one or more of the characteristics of the various processes described herein with reference to process 800. For example, the first response of process 700 can be the operation corresponding to the first user interface object of process 800 (e.g., the subject of process 700 is identified before performing the operation corresponding to the first user interface object). For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve responding to users. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for responding to users. Accordingly, use of such personal information data enables users to have a computer system perform operations for responding to users. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more input devices and one or more display generation components:
while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; and
in response to detecting the input that includes the identification of the first visual characteristic:
in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and
in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

2. The method of claim 1, wherein the first visual characteristic includes a general visual characteristic, wherein the first set of one or more visual characteristics includes a visual characteristic that is a first variation of the general visual characteristic, wherein the second set of one or more visual characteristics includes a visual characteristic that is a second variation of the general visual characteristic, wherein the second variation is different from the first variation, wherein the criterion that is satisfied when the first visual characteristic corresponds to the first set of one or more visual characteristics is satisfied when the general visual characteristic is determined to correspond to the first variation more than the second variation, and wherein the criterion that is satisfied when the first visual characteristic corresponds to the second set of one or more visual characteristics is satisfied when the general visual characteristic is determined to correspond to the second variation more than the first variation.

3. The method of claim 1, wherein the first user interface object is a first type of user interface object, and wherein the second interface object is the first type of user interface object.

4. The method of claim 1, wherein the first visual characteristic corresponds to the first set of one or more visual characteristics when the first visual characteristic has a greater degree of relatedness with the first set of one or more visual characteristics than the first visual characteristic with the second set of or more visual characteristics, and wherein the first visual characteristic corresponds to the second set of one or more visual characteristics when the first visual characteristic has a greater degree of relatedness with the second set of one or more visual characteristics than the first visual characteristic with the first set of or more visual characteristics.

5. The method of claim 1, wherein the first visual characteristic corresponds to the first set of one or more visual characteristics when an amount of a visual characteristic of the first set of one or more visual characteristics that corresponds to the first visual characteristic is greater than an amount of a visual characteristic of the second set of one or more visual characteristics that corresponds to the first visual characteristic, and wherein the first visual characteristic corresponds to the second set of one or more visual characteristics when the amount of the visual characteristic of the second set of one or more visual characteristics that corresponds to the first visual characteristic is greater than the amount of the visual characteristic of the first set of one or more visual characteristics that corresponds to the first visual characteristic.

6. The method of claim 1, further comprising:
in response to detecting the input that includes the identification of the first visual characteristic and in accordance with a determination that a third set of one or more criteria, different from the first set of one or more criteria and the second set of one or more criteria, is satisfied, wherein the third set of one or more criteria includes a first criterion that is satisfied when the first visual characteristic does not correspond to the first set of one or more visual characteristics, wherein the third set of one or more criteria includes a second criterion that is satisfied when the first visual characteristic does not correspond to the second set of one or more visual characteristics, forgoing performance of the operation.

7. The method of claim 1, further comprising:
while displaying the first user interface object with the first set of one or more visual characteristics and the second user interface object with the second set of one or more visual characteristics, detecting, via the one or more input device, a selection input different from the input that includes the identification of the first visual characteristic; and
in response to detecting the selection input:
in accordance with a determination that the selection input corresponds to the first interface object, performing the operation that corresponds to the first user interface object; and
in accordance with a determination that the second input corresponds to the second interface object, performing the operation that corresponds to the second user interface object.

8. The method of claim 1, wherein the operation corresponding to the first user interface object is a first type of operation, and wherein the operation corresponding to the second user interface object is the first type of operation.

9. The method of claim 1, wherein performing the operation corresponding to the first user interface object includes displaying, via the one or more displaying generation components, first content, and wherein performing the operation corresponding to the second user interface object includes displaying, via the one or more displaying generation components, second content different from the first content.

10. The method of claim 1, wherein:
the computer system is in communication with one or more audio generation components;
performing the operation corresponding to the first user interface object includes outputting, via the one or more audio generation components, first audio content; and
performing the operation corresponding to the second user interface object includes outputting, via one or more audio generation components, second audio content different from the first audio content.

11. The method of claim 1, wherein the input that includes the identification of the first visual characteristic is a first input, the method further comprising:
while performing the operation corresponding to the first user interface object, detecting, via the one or more input devices, a second input different from first input; and
in response to detecting the second input, ceasing performance of the operation corresponding to the first user interface object.

12. The method of claim 1, further comprising:
in response to detecting the input that includes the identification of the first visual characteristic and in accordance with the determination that the first set of one or more criteria is satisfied, forgoing performance of the operation corresponding to the second user interface object.

13. The method of claim 1, wherein performing the operation corresponding to the first user interface object includes displaying, via the one or more display generation components, the first user interface object with a third set of one or more visual characteristics different from the first set of one or more visual characteristics.

14. The method of claim 13, further comprising:
while performing the operation corresponding to the first user interface object, ceasing display of, via the one or more display generation components, the second user interface object.

15. The method of claim 14, further comprising:
after performing the operation corresponding to the first user interface object, displaying, via the one or more display generation components, the second user interface object.

16. The method of claim 1, wherein the first set of one or more visual characteristics and the second set of one or more visual characteristics are the same type of visual characteristic.

17. The method of claim 1, further comprising:
while performing the operation corresponding to the first user interface, ceasing display of the second user interface object while maintaining display of the first user interface object.

18. A non-transitory computer-readable storage medium storing one or more programs configured to be executed by one or more processors of a computer system that is in communication with one or more input devices and one or more display generation components, the one or more programs including instructions for:
while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object; and
in response to detecting the input that includes the identification of the first visual characteristic:
in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and
in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.

19. A computer system configured to communicate with one or more input devices and one or more display generation components, the computer system comprising:
one or more processors; and
memory storing one or more programs configured to be executed by the one or more processors, the one or more programs including instructions for:
while displaying, via the one or more display generation components, a first user interface object with a first set of one or more visual characteristics and a second user interface object with a second set of one or more visual characteristics different from the first set of one or more visual characteristics, detecting, via the one or more input device, an input that includes an identification of a first visual characteristic, wherein the second user interface object is different from the first user interface object;
in response to detecting the input that includes the identification of the first visual characteristic:
in accordance with a determination that a first set of one or more criteria is satisfied, wherein the first set of one or more criteria includes a criterion that is satisfied when the first visual characteristic corresponds to the first set of one or more visual characteristics, performing an operation corresponding to the first user interface object; and
in accordance with a determination that a second set of one or more criteria, different from the first set of one or more criteria, is satisfied, wherein the second set of one or more criteria includes a criterion that is satisfied when the first visual characteristic corresponds to the second set of one or more visual characteristics, performing an operation corresponding to the second user interface object.
